(19) United States
(12) Patent Application Publication
(10) Pub. No.: US 2003/0162685 A1
(43) Pub. Date: Aug. 28, 2003

(54) Solid cleaning composition including stabilized active oxygen component

(76) Inventors: Victor Fuk-Pong Man, St. Paul, MN (US); Stephan Maria Hubig, Maplewood, MN (US); Kim R. Smith, Woodbury, MN (US); David William Gohl, St. Paul, MN (US); Steven Eugene Lentsch, St. Paul, MN (US); Keith Edward Olson, Apple Valley, MN (US)

Correspondence Address: MERCHANT & GOULD PC, P.O. BOX 2903, MINNEAPOLIS, MN, 55402-0903, US

(21) Appl. No.: 10/214,625

(22) Filed: Aug. 7, 2002

Related U.S. Application Data
(63) Continuation-in-part of application No. 09/874,841, filed on Jun. 5, 2001.
(60) Provisional application No. 60/310,592, filed on Aug. 7, 2001.
(60) Provisional application No. 60/334,577, filed on Nov. 30, 2001.

(51) Int. Cl. C11D 17/00

(52) U.S. Cl. 510/445; 510/367; 510/375; 510/444

(57) ABSTRACT

A solid cleaning composition comprises a source of active oxygen agent within a binder complex. The solid is formed by a binding agent that forms the ingredients into a solid. The binding agent is a composition formed by the solidification of a mixture of an organic sequestrant, including phosphonate or aminocarboxylic acid or mixtures thereof, an active oxygen compound, and water. The solid composition can be dissolved in an aqueous solution creating an aqueous concentrate of the active oxygen at a useful concentration. The binding agent can also be used to bind additional functional materials and form a solid cleaning composition comprising the source of stabilized active oxygen as well as the additional functional material.

### CROSS REFERENCE TO RELATED APPLICATION

The present application is a continuation in part of U.S. patent application Ser. No. 09/874,841 filed Jun. 5, 2001, which is incorporated herein by reference. The present application also claims priority to U.S. Provisional Patent Application Serial No. 60/310,592, filed Aug. 7, 2001, and No. 60/334,577, filed Nov. 30, 2001, the disclosures of which are incorporated herein by reference.

### FIELD OF THE INVENTION

The invention relates to a solid cleaning composition, and more particularly to a solid cleaning composition including a source of stabilized active oxygen incorporated therein. In some embodiments, the solid composition can be dissolved in an aqueous solution creating an aqueous concentrate of the active oxygen or active oxygen containing compounds at a useful concentration.

In one respect, the cleaning composition includes a novel binding agent that includes the source of stabilized active oxygen. The binding agent can also be used to bind additional functional materials and form a solid cleaning composition including the source of stabilized active oxygen as well as the additional functional material(s).

The solid, water soluble or dispersible cleaning composition is typically dispensed using a dispenser which dissolves the solid cleaning composition creating an aqueous concentrate of the active oxygen agent and any additional functional material at a useful concentration.

### BACKGROUND OF THE INVENTION

The use of solidification technology and solid block detergents in institutional and industrial operations was pioneered in the SOLID POWER® brand technology claimed in Fernholz et al., U.S. Reissue Pat. Nos. 32,762 and 32,818. Additionally, sodium carbonate hydrate cast solid products using substantially hydrated sodium carbonate materials was disclosed in Heile et al., U.S. Pat. Nos. 4,595,520 and 4,680,134.

In recent years attention has been directed to producing highly effective detergent materials from less caustic materials such as soda ash also known as sodium carbonate. Early work in developing the sodium carbonate based detergents found that sodium carbonate hydrate based materials swelled, (i.e., were dimensionally unstable after solidification). Such swelling can interfere with packaging, dispensing and use.

Although recent developments have resolved some of the stability problems, there is still a need for stable solid cleaning compositions having stable binding agents.

It is also desirable to incorporate a stabilized bleaching agent into a solid cleaning composition. However, stability problems of most bleaching agents prohibited the easy incorporation of bleaching agents into solid cleaning compositions. This is especially true when such compositions are processed at higher temperatures using techniques such as extrusion. In many previous attempts at incorporation of bleaching agents into solid cleaning compositions, the bleaching agent had to be encapsulated to prevent full degradation during processing. Such encapsulation provided for additional complexity and cost in the formation and production of solid cleaning agents.

### SUMMARY OF THE INVENTION

The inventors have developed an improved solid cleaning composition including a source of stabilized active oxygen. At least some embodiments include a novel binding agent including the source of stabilized active oxygen.

In one respect, the invention relates to a solid composition including a solidified mixture, the mixture including: an organic sequestrant including phosphonate, aminocarboxylate, or mixtures thereof; an active oxygen compound; and water. Additional functional materials can optionally be included in the solidified mixture.

In another respect, the invention relates to a solid composition formed through the process of solidifying the necessary components.

In another respect, the invention relates to a method of manufacturing a solid cleaning composition, the method including: solidifying a mixture, the mixture including the organic sequestrant, the active oxygen compound, and water.

In some embodiments, a solid cleaning composition is made using a new binding agent that is intentionally prepared in the solidifying mixture. The new binding agent includes the organic sequestrant, the active oxygen compound, and water. In our experimentation with respect to the use of organic sequestrants and active oxygen compounds in solid cleaning compositions, conclusive evidence for the existence of a new complex has been found and distinguished from earlier solids. The stability of the active oxygen compound is increased due to its inclusion within the binder complex, thereby increasing the degradation temperature of the active oxygen within the composition.

In some embodiments, other optional ingredients can be incorporated into the composition, including, for example, salt or additional salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aid composition, threshold agent or system, aesthetic enhancing agent (i.e., dye, odorant, perfume), optical brightener, lubricant composition, bleaching agent or additional bleaching agent, enzyme, effervescent agent, activator for the active oxygen compound, other such additives or functional ingredients, and the like, and mixtures thereof. Advantageously, builder is selected to be and is employed at a concentration that is effective to stabilize active oxygen compound in a liquid composition, such as a liquid use or concentrate composition.

In some embodiments, a solid cleaning composition is provided. The mixture is formed into a solid using techniques generally know in the art, for example extrusion, pelletizing or casting. The new binder material or binding agent provides a source of stabilized active oxygen, and is dispersed throughout and forms the solid or agglomeration. The solid optionally contains the additional functional ingredients to provide desired properties or characteristics. The binding component is distributed throughout the solid and binds other optional components into a stable solid.

Solid compositions and methods embodying the invention are suitable for preparing a broad variety of solid compositions, as for example solid cleaning compositions, such as a cast, extruded, or formed pellet, block, tablet, or in some other embodiments, can be formed into flakes, grains, and the like. Such compositions can be used in a broad variety of cleaning and destaining applications.

In an embodiment, the compositions can be formulated for cleaning or sanitizing carpet or upholstery. Such carpet or upholstery cleaning or sanitizing compositions can be powder, other solid, or agglomerate compositions and can include an organic sequestrant including phosphonate, aminocarboxylate, or mixtures thereof; an active oxygen compound; water; and surfactant. The methods of cleaning or sanitizing carpet or upholstery include applying to the carpet or upholstery such a solid or agglomerate composition or a use solution of one of these compositions.

In an embodiment, the compositions can be formulated for cleaning or sanitizing laundry. Such laundry cleaning or sanitizing compositions can be powder, other solid, agglomerate, or paste compositions and can include an organic sequestrant including phosphonate, aminocarboxylate, or mixtures thereof; an active oxygen compound; water; and surfactant. The methods of cleaning or sanitizing laundry include applying to the laundry a use solution of one of these compositions.

### BRIEF DESCRIPTION OF THE DRAWINGS

FIG. 1 is a differential scanning calorimeter (DSC) scans of data relating to a solid composition including a solidified mixture of an organic sequestrant including a phosphonate, and an active oxygen compound (sodium percarbonate), and other additives. The scan indicates a peak at around 125° C., and an exotherm just above 125° C. This indicates a new binding agent, involving percarbonate, stabilizing it from a degradation temperature of about 50° C. to about 130° C.; a stability improvement of about 80° C.

FIG. 2 is a digital photograph of a carpet before cleaning with a composition according to and by a method of the present invention.

FIG. 3 is a digital photograph of the carpet of FIG. 2 after cleaning with a conventional, commercial carpet cleaning detergent.

FIG. 4 is a digital photograph of the carpet of FIG. 2 after cleaning with a composition according to and by a method of the present invention.

FIG. 5 is a digital photograph of the carpet of FIG. 2 after a portion was cleaned with a conventional, commercial carpet cleaning detergent and another portion was cleaned with a composition according to and by a method of the present invention.

FIG. 6 is a digital photograph of a carpet extractor as employed for cleaning the carpet.

FIG. 7 illustrates the stability of active oxygen compound in liquid compositions including aminocarboxylate and polycarboxylic acid builder.

### DETAILED DESCRIPTION OF THE INVENTION

Terms and Definitions

An “active oxygen compound” is an agent containing or acting as a source of active oxygen. Preferred active oxygen compounds release active oxygen in aqueous solutions.

A “peroxygen compound” or “peroxide” means a compound containing a peroxy moiety, —O—O—, or adducts of such compounds, in which at least one of the oxygen atoms is active.

An “active oxygen compound adduct” is a physical adduct containing active oxygen compound associated with a second molecule.

A “peroxygen compound adduct” is a physical adduct containing peroxygen compound associated with a second molecule.

A “hydrogen peroxide adduct” or a “peroxyhydrate” is a crystalline adduct containing molecular hydrogen peroxide. On dissolution in water, hydrogen peroxide adducts (peroxyhydrates) liberate hydrogen peroxide into solution.

“Inorganic active oxygen compound(s)” are active oxygen compounds wherein the active oxygen is attached to an inorganic group, or it can bridge two inorganic groups.

“Inorganic peroxide” compounds are peroxygen compound wherein the peroxide group is attached to an inorganic group through one or two of the oxygen atoms, or it can bridge two inorganic groups.

“Organic active oxygen compound(s)” are active oxygen compounds wherein the active oxygen is attached to a group containing carbon, or it can bridge two groups containing carbon.

“Organic peroxide” compounds are peroxygen compounds wherein the peroxide group is attached to a group containing carbon or phosphorus through one or two of the oxygen atoms, or it can bridge two groups containing carbon.

“Phosphonate” means a class of organophosphonic acids including one of the general formula:

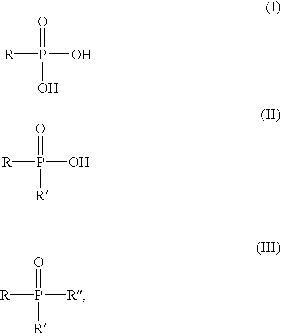

and acceptable salts and esters thereof, wherein R, R′ and R′″ are each organic groups. The phosphonate of formula I is typically preferred.

An “aminocarboxylic acid” is an acid having at least one amino group and at least one carboxylic acid substituent.

An “alkali metal carbonate” is a compound including at least one alkali metal and at least one carbonate group.

The term “functional material” or “functional additives” refers to an active compound or material that affords desirable properties to the solid or dissolved composition. For example, the functional material can afford desirable properties to the solid composition such as enhancing solidification characteristics or dilution rate. The functional material can also, when dissolved or dispersed in an aqueous phase, provide a beneficial property to the aqueous material when used. Examples of functional materials include chelating/sequestering agent, alkalinity source, surfactant, cleaning agent, softening agent, buffer, anti-corrosion agent, bleach activators secondary hardening agent or solubility modifier, detergent filler, defoamer, anti-redeposition agent, antimicrobials, rinse aid compositions, a threshold agent or system, aesthetic enhancing agent (i.e., dye, perfume), lubricant compositions, additional bleaching agents, functional salts, hardening agents, solubility modifiers, enzymes, other such additives or functional ingredients, and the like, and mixtures thereof. Functional materials added to a composition will vary according to the type of composition being manufactured, and the intended end use of the composition.

“Cleaning” means to perform or aid in soil removal, bleaching, microbial population reduction, or combination thereof.

As used herein, a solid cleaning composition refers to a cleaning composition in the form of a solid such as a powder, a flake, a granule, a pellet, a tablet, a lozenge, a puck, a briquette, a brick, a solid block, a unit dose, or another solid form known to those of skill in the art.

As used herein, the term “agglomerate” refers to a cleaning composition including particles gathered together into a ball, mass, or cluster; which are loosely bound, foam-like structures having varying degrees of open spaces or voids.

As used herein, the term “microorganism” refers to any noncellular or unicellular (including colonial) organism. Microorganisms include all prokaryotes. Microorganisms include bacteria (including cyanobacteria and Mycobacteria), lichens, fungi, mold, protozoa, virinos, viroids, viruses, and some algae. As used herein, the term “microbe” is synonymous with microorganism.

As used herein, weight percent (wt-%), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can effect two kinds of microbial cell damage. The first is a lethal, irreversible action resulting in complete microbial cell destruction or incapacitation. The second type of cell damage is reversible, such that if the organism is rendered free of the agent, it can again multiply. The former is termed bacteriocidal and the later, bacteriostatic. A sanitizer and a disinfectant are, by definition, agents which provide antibacterial or bacteriocidal activity. In contrast, a preservative is generally described as an inhibitor or bacteriostatic composition.

For the purpose of this patent application, successful reduction of microorganisms is achieved when the populations of microorganisms are reduced by at least about 0.3-1 log₁₀. In this application, such a population reduction is the minimum acceptable for the processes. Any increased reduction in population of microorganisms is an added benefit that provides higher levels of protection.

For example, a carpet sanitizer results in a 99.9% reduction (3 log order reduction) in one or more microorganisms in a carpet sample in a test procedure defined by the EPA at US EPA—Efficacy Data Requirements: Carpet Sanitizers DIS/TSS-8 Apr. 18, 1981, the contents of which are incorporated herein by reference.

By way of further example, a laundry sanitizer results in 99.9% reduction (3 log order reduction) in one or more microorganisms in a laundry sample in a test procedure defined by the EPA at US EPA—EFFICACY DATA AND LABELING REQUIREMENTS Laundry Additives—Disinfection and Sanitization DIS/TSS-13, Apr. 4, 1980, the contents of which are incorporated herein by reference. A suitable simulated use protocol for testing laundry sanitizers is described in Petrocci, A. N., and Clarke, P., 1969, “Proposed Test Method for Antimicrobial Laundry Additives”, J. of American Oil Chemists, 52, 836-842, which is incorporated herein by reference.

The Solid Composition

In its most basic aspect, the composition includes a solidified mixture of organic sequestrant including a phosphonate, an aminocarboxylic acid, or mixtures thereof; an active oxygen compound, and water. At least a portion of the components of the mixture, including organic sequestrant, active oxygen compound, and water, during solidification, complex to form at least a portion of a binding agent. As the mixture solidifies, the binding agent forms to bind and solidify the components of the mixture. The solidified mixture can be used alone as a source of active oxygen, for use in such applications as bleaching. The solidified mixture can optionally include additional functional materials, and the additional functional materials are bound within the solidified mixture by the formation of the binding agent.

It should be noted that in some embodiments, water is optional. For example, in some embodiments, where the active oxygen compound is liquid, for example liquid hydrogen peroxide, water, or additional water, is optionally not included in the composition.

Typically, the formation of the binder acts to increase the stability of the active oxygen compound. In many embodiments, the stabilized active oxygen compound within the solidified mixture has a higher decomposition temperature than the active oxygen compound would have when it is not within the solidified mixture. In some preferred embodiments, the solidified composition has a melting transition temperature in the range of 120° C. to 160° C. However, other embodiments may have a melting transition temperature outside of this range. Typically, the solid compositions exhibit excellent storage stability of the active oxygen. For example, in an embodiment, more than 80% of the active oxygen can remain after 60 days of storage at room temperature or up to 100° F.

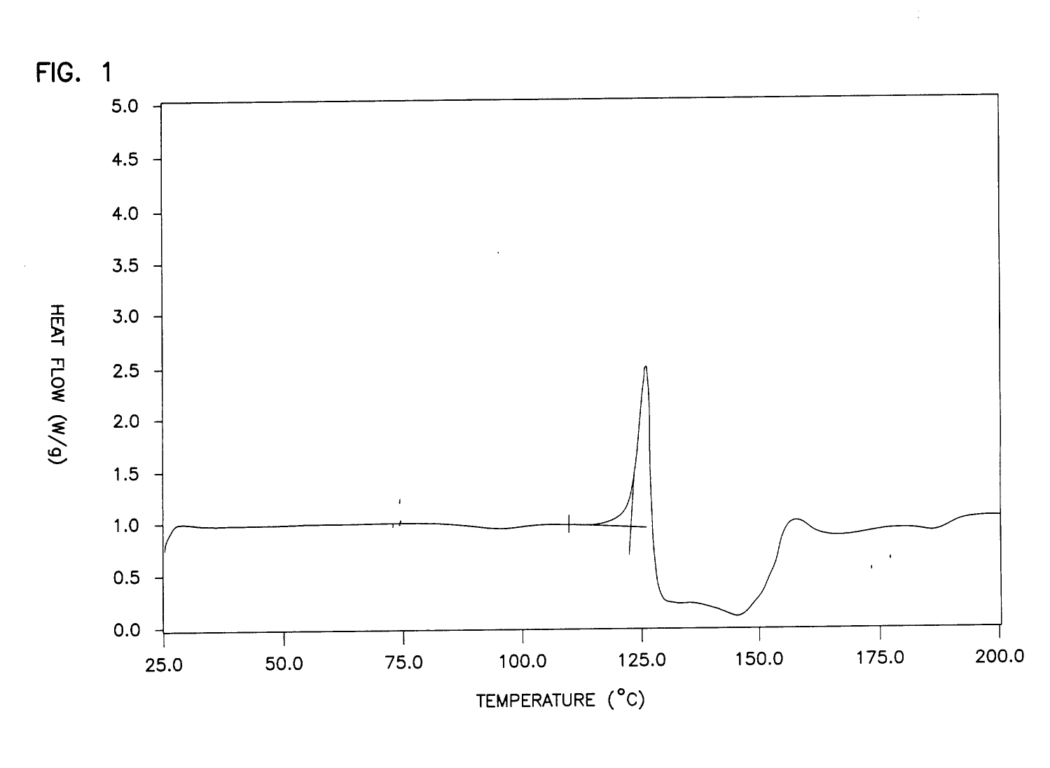

In one example, with reference to FIG. 1, a solid composition including a solidified mixture of an organic sequestrant including a phosphonate, an active oxygen compound (sodium percarbonate), and water and other additives. This composition includes a binding agent that improved the stability of the percarbonate. FIG. 1 shows data from a differential scanning calorimeter (DSC) scan of the solid composition. The scan indicates a peak at around 125° C., and an exotherm just above 125° C. This indicates a new binding agent, involving the percarbonate, stabilizing it from a degradation temperature of about 50° C. to about 130° C.; a stability improvement of about 80° C. Similarly, solid perborate compositions can be stabilized, exhibiting increases in degradation temperature of about 60 to 65° C. The solid compositions can be stabilized even in the presence of an activator of the active oxygen compound, which would generally have been expected to react with and destabilize the active oxygen compound or to change it to another form. Such stabilization can be achieved with the active oxygen compounds and stabilizers of the present invention.

Organic Sequestrant

Suitable organic sequestrant includes organic phosphonate, aminocarboxylic acid, or mixtures thereof.

Organic Phosphonate

Appropriate organic phosphonates include those that are suitable for use in forming the solidified composition with the active oxygen compound and water. Organic phosphonates include organic-phosphonic acids, and alkali metal salts thereof. Some examples of suitable organic phosphonates include:

1-hydroxyethane-1,1-diphosphonic acid: CH₃C(OH)[PO(OH)₂]₂;

aminotri(methylenephosphonic acid): N[CH₂PO(OH)₂]₃;

aminotri(methylenephosphonate), sodium salt

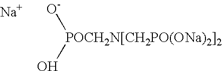

2-hydroxyethyliminobis(methylenephosphonic acid): HOCH₂CH₂N[CH₂PO(OH)₂]₂;

diethylenetriaminepenta(methylenephosphonic acid): (HO)₂POCH₂N[CH₂CH₂N[CH₂PO(OH)₂]₂]₂;

diethylenetriaminepenta(methylenephosphonate), sodium salt: C₉H₍₂₈₋ₓ₎N₃NaₓO₁₅P₅ (x=7);

hexamethylenediamine(tetramethylenephosphonate), potassium salt: C₁₀H₍₂₈₋ₓ₎N₂KₓO₁₂P₄ (x=6);

bis(hexamethylene)triamine(pentamethylenephosphonic acid): (HO₂)POCH₂N[(CH₂)₆N[CH₂PO(OH)₂]₂]₂; and

phosphorus acid H₃PO₃; and other similar organic phosphonates, and mixtures thereof.

These materials are well known sequestrants, but have not been reported as components in a solidification complex material including an active oxygen compound.

A preferred organic phosphonate combination is ATMP and DTPMP. A neutralized or alkaline phosphonate, or a combination of the phosphonate with an alkali source prior to being added into the mixture such that there is little or no heat or gas generated by a neutralization reaction when the phosphonate is added is preferred.

For laundry cleaning or sanitizing compositions, preferred organic phosphonate sequestrants include ATMP.

Aminocarboxylic Acid

The organic sequestrant can also include aminocarboxylic acid type sequestrant. Appropriate aminocarboxylic acid type sequestrants include those that are suitable for use in forming the solidified composition with the active oxygen compound and water. Aminocarboxylic acid type sequestrant can include the acids, or alkali metal salts thereof. Some examples of aminocarboxylic acid materials include amino acetates and salts thereof. Some examples include the following:

N-hydroxyethylaminodiacetic acid;

hydroxyethylenediaminetetraacetic acid, nitrilotriacetic acid (NTA);

ethylenediaminetetraacetic acid (EDTA);

N-hydroxyethyl-ethylenediaminetriacetic acid (HEDTA);

diethylenetriaminepentaacetic acid (DTPA); and

alanine-N,N-diacetic acid;

and the like; and mixtures thereof.

For carpet or upholstery cleaning or sanitizing compositions, preferred aminocarboxylates include ethylenediamine tetraacetic acid (EDTA), diethylenetriamine pentaacetic acid (DTPA), their alkali metal salts, and mixtures thereof.

Active Oxygen Compound

The active oxygen compound acts to provide a source of active oxygen, but as discussed above, also preferably acts to form at least a portion of the solidification or binding agent. The active oxygen compound can be inorganic or organic, and can be a mixture thereof. Some examples of active oxygen compound include peroxygen compounds, and peroxygen compound adducts that are suitable for use in forming the binding agent of the invention.

Many active oxygen compounds are peroxygen compounds. Any peroxygen compound generally known, and that preferably can function as part of the binding agent can be used. Examples of suitable peroxygen compounds include inorganic and organic peroxygen compounds, or mixtures thereof.

Inorganic Active Oxygen Compounds

Examples of inorganic active oxygen compounds include the following types of compounds or sources of these compounds, or alkali metal salts including these types of compounds, or forming an adduct therewith:

hydrogen peroxide;

group 1 (IA) active oxygen compounds, for example lithium peroxide, sodium peroxide, and the like;

group 2 (IIA) active oxygen compounds, for example magnesium peroxide, calcium peroxide, strontium peroxide, barium peroxide, and the like;

group 12 (IIB) active oxygen compounds, for example zinc peroxide, and the like;

group 13 (IIIA) active oxygen compounds, for example boron compounds, such as perborates, for example sodium perborate hexahydrate of the formula Na₂[Br₂(O₂)₂(OH)₄].6H₂O (also called sodium perborate tetrahydrate and formerly written as NaBO₃.4H₂O); sodium peroxyborate tetrahydrate of the formula Na₂Br₂(O₂)₂[(OH)₄.]4H₂O (also called sodium perborate trihydrate, and formerly written as NaBO₃.3H₂O); sodium peroxyborate of the formula Na₂[B₂(O₂)₂(OH)₄] (also called sodium perborate monohydrate and formerly written as NaBO₃.H₂O); and the like; preferably perborate;

group 14 (IVA) active oxygen compounds, for example persilicates and peroxycarbonates, which are also called percarbonates, such as persilicates or peroxycarbonates of alkali metals; and the like; preferably percarbonate, preferably persilicate;

group 15 (VA) active oxygen compounds, for example peroxynitrous acid and its salts; peroxyphosphoric acids and their salts, for example, perphosphates; and the like; preferably perphosphate;

group 16 (VIA) active oxygen compounds, for example peroxysulfuric acids and their salts, such as peroxymonosulfuric and peroxydisulfuric acids, and their salts, such as persulfates, for example, sodium persulfate; and the like; preferably persulfate;

group VIa active oxygen compounds such as sodium periodate, potassium perchlorate and the like.

Other active inorganic oxygen compounds can include transition metal peroxides; and other such peroxygen compounds, and mixtures thereof.

Preferably, the compositions and methods of the present invention employ certain of the inorganic active oxygen compounds listed above. Preferred inorganic active oxygen compounds include hydrogen peroxide, hydrogen peroxide adduct, group IIIA active oxygen compound group, VIA active oxygen compound, group VA active oxygen compound, group VIIA active oxygen compound, or mixtures thereof. Preferred examples of such inorganic active oxygen compounds include percarbonate, perborate, persulfate, perphosphate, persilicate, or mixtures thereof. Hydrogen peroxide presents one preferred example of an inorganic active oxygen compound. Hydrogen peroxide can be formulated as a mixture of hydrogen peroxide and water, e.g., as liquid hydrogen peroxide in an aqueous solution. The mixture of solution can include about 5 to about 40 wt-% hydrogen peroxide, preferably 5 to 50 wt-% hydrogen peroxide.

In an embodiment, the preferred inorganic active oxygen compounds include hydrogen peroxide adduct. For example, the inorganic active oxygen compounds can include hydrogen peroxide, hydrogen peroxide adduct, or mixtures thereof. Any of a variety of hydrogen peroxide adducts are suitable for use in the present compositions and methods. For example, suitable hydrogen peroxide adducts include percarbonate salt, urea peroxide, peracetyl borate, an adduct of H₂O₂ and polyvinyl pyrrolidone, sodium percarbonate, potassium percarbonate, mixtures thereof, or the like. Preferred hydrogen peroxide adducts include percarbonate salt, urea peroxide, peracetyl borate, an adduct of H₂O₂ and polyvinyl pyrrolidone, or mixtures thereof. Preferred hydrogen peroxide adducts include sodium percarbonate, potassium percarbonate, or mixtures thereof, preferably sodium percarbonate.

Organic Active Oxygen Compounds

Any of a variety of organic active oxygen compounds can be employed in the compositions and methods of the present invention. For example, the organic active oxygen compound can be a peroxycarboxylic acid, such as a mono- or di-peroxycarboxylic acid, an alkali metal salt including these types of compounds, or an adduct of such a compound. Preferred peroxycarboxylic acids include C₁-C₂₄ peroxycarboxylic acid, salt of C₁-C₂₄ peroxycarboxylic acid, ester of C₁-C₂₄ peroxycarboxylic acid, diperoxycarboxylic acid, salt of diperoxycarboxylic acid, ester of diperoxycarboxylic acid, or mixtures thereof.

Preferred peroxycarboxylic acids include C₁-C₁₀ aliphatic peroxycarboxylic acid, salt of C₁-C₁₀ aliphatic peroxycarboxylic acid, ester of C₁-C₁₀ aliphatic peroxycarboxylic acid, or mixtures thereof; preferably salt of or adduct of peroxyacetic acid; preferably peroxyacetyl borate. Preferred diperoxycarboxylic acids include C₄-C₁₀ aliphatic diperoxycarboxylic acid, salt of C₄-C₁₀ aliphatic diperoxycarboxylic acid, or ester of C₄-C₁₀ aliphatic diperoxycarboxylic acid, or mixtures thereof; preferably a sodium salt of perglutaric acid, of persuccinic acid, of peradipic acid, or mixtures thereof.

Organic active oxygen compounds include other acids including an organic moiety. Preferred organic active oxygen compounds include perphosphonic acids, perphosphonic acid salts, perphosphonic acid esters, or mixtures or combinations thereof.

Active Oxygen Compound Adducts

Active oxygen compound adducts include any generally known, and that preferably can function as a source of active oxygen and as part of the solidified composition. Hydrogen peroxide adducts, or peroxyhydrates, are preferred. Some examples of active oxygen compound adducts include the following:

alkali metal percarbonates, for example sodium percarbonate (sodium carbonate peroxyhydrate), potassium percarbonate, rubidium percarbonate, cesium percarbonate, and the like; ammonium carbonate peroxyhydrate, and the like; urea peroxyhydrate, peroxyacetyl borate; an adduct of H₂O₂ polyvinyl pyrrolidone, and the like, and mixtures of any of the above.

Alkali metal percarbonates are preferred, with sodium percarbonate being the most preferred. However, it should be noted that in some embodiments, as illustrated in the examples, the active oxygen compound does not include sodium percarbonate.

Solid Compositions Including Active Oxygen Compound

In certain embodiments, the solid composition includes about 10 to about 80 wt-% active oxygen compound; about 50 to about 80 wt-% active oxygen compound; about 40 to about 80 wt-% active oxygen compound; about 50 to about 70 wt-% active oxygen compound; about 50 to about 65 wt-% active oxygen compound; about 50 to about 60 wt-% active oxygen compound; about 60 to about 80 wt-% active oxygen compound; about 60 to about 90 wt-% active oxygen compound; about 70 to about 95 wt-% active oxygen compound; about 80 to about 90 wt-% active oxygen compound; or about 5 to about 30 wt-% active oxygen compound.

In certain embodiments, the solid composition includes about 40 to about 90 wt-% active oxygen compound; about 50 to about 80 wt-% active oxygen compound; about 60 to about 80 wt-% active oxygen compound; about 50 to about 70 wt-% active oxygen compound; about 50 to about 60 wt-% active oxygen compound; about 80 wt-% active oxygen compound; or about 55 wt-% active oxygen compound.

In certain embodiments, the solid composition includes about 30 to about 80 wt-% active oxygen compound; about 40 to about 70 wt-% active oxygen compound; about 5 to about 60 wt-% active oxygen compound; about 25 to about 60 wt-% active oxygen compound; about 50 to about 60 wt-% active oxygen compound; or about 55 wt-% active oxygen compound.

In certain embodiments, the solid composition includes about 5 to about 60 wt-% active oxygen compound; about 10 to about 25 wt-% active oxygen compound; about 30 to about 40 wt-% active oxygen compound; or about 50 to about 60 wt-% active oxygen compound.

In certain embodiments, the solid composition includes as a lower limit about 5, about 10, about 20, about 25, about 30, about 40, about 50, about 60, about 70, or about 80 wt-% active oxygen compound up to an upper limit of about 20, about 25, about 30, about 40, about 50, about 60, about 70, about 80, or about 90 wt-% active oxygen compound, or each of these end points not modified by about. In certain embodiments, the solid composition includes about 30, about 40, about 50, about 55, about 60, about 65, about 70, about 75, about 80, about 85, or about 90 wt-% active oxygen compound, or any of these amounts not modified by about.

Water

Water, or a source of water, preferably purified or distilled water, is used a component of the solid compositions. However, as discussed briefly above, in some embodiments, water is optional. For example, in some embodiments, where the active oxygen compound is liquid, for example liquid hydrogen peroxide, water is optionally not included in the composition.

Compositions Including Organic Sequestrant, Active Oxygen Compound, and, Optionally, Water

The basic ingredients in the solid composition, and the ranges of molecular equivalents, are shown in the following Table 1:

TABLE 1
Composition Mole Ratios of Base Materials
(based on composition total weight)

| | | Preferred Range | More Preferred |
|---|---|---|---|
| | Range of Molar | of Molar | Range of Molar |
| | Equivalents in the | Equivalents in the | Equivalents in the |
| Component | Composition | Composition | Composition |
| Organic | 1 mole per moles | 1 mole per moles | 1 mole per moles |
| Sequestrant | of active oxygen | of active oxygen | of active oxygen |
| (Phosphonate | compound and | compound and | compound and |
| or | water as listed | water as listed | water as listed |
| amino- | below | below | below |
| carboxylate | | | |
| or mixtures | | | |
| thereof) | | | |
| Active Oxygen | 20 or less moles | 10 or less moles | 8 or less moles, |
| Compound | per mole of | per mole of | and in some |
| | organic | organic | embodiments, |
| | sequestrant | sequestrant, | more preferably 7 |
| | | preferably about 3 | or less moles per |
| | | to about 10 moles | mole of organic |
| | | per mole of | sequestrant, |
| | | organic | |
| | | sequestrant | |
| Water | 50 or less moles | 20 or less moles | in the range of 5 |
| | per mole of | per mole of | to 15 moles per |
| | organic | organic | mole of organic |
| | sequestrant | sequestrant | sequestrant |

The weight percent of the components will vary, depending upon the particular compounds used, due to the differences in molecular weight of various usable components.

Preferably, the active oxygen compound includes a peroxygen moiety. Preferably, in such an embodiment the combined moles of peroxygen moiety and water in the mixture are greater than the number of moles of active oxygen compound. Preferably, in such embodiments, the ratio of combined moles of peroxygen moiety and water to moles of active oxygen compound is greater than 1:1 and less than 1.3:1.

In some embodiments, for example where the active oxygen compound is sodium percarbonate (sodium carbonate peroxyhydrate—a sodium carbonate-hydrogen peroxide adduct), it is preferred that the combined moles of H₂O₂ and H₂O are greater than the number of moles of sodium carbonate. For example, in such embodiments, it is not necessary to provide an excess of sodium carbonate in the composition over the amount of “available water”, as that term has been used, for example, in EP 0363852 A1.

Additives

Solid cleaning compositions made according to the invention may further include additional functional materials or additives that provide a beneficial property, for example, to the composition in solid form or when dispersed or dissolved in an aqueous solution, e.g., for a particular use. Examples of conventional additives include one or more of each of salt or additional salt, chelating/sequestering agent, alkalinity source, surfactant, detersive polymer, cleaning agent, rinse aid composition, softener, pH modifier, source of acidity, anti-corrosion agent, secondary hardening agent, solubility modifier, detergent builder, detergent filler, defoamer, anti-redeposition agent, antimicrobial, rinse aid composition, threshold agent or system, aesthetic enhancing agent (i.e., dye, odorant, perfume), optical brightener, lubricant composition, bleaching agent or additional bleaching agent, enzyme, effervescent agent, activator for the active oxygen compound, other such additives or functional ingredients, and the like, and mixtures thereof.

Adjuvants and other additive ingredients will vary according to the type of composition being manufactured, and the intended end use of the composition. Preferably, the composition includes as an additive one or more of source of alkalinity, surfactant, detergent builder, cleaning enzyme, detersive polymer, antimicrobial, activators for the active oxygen compound, or mixtures thereof.

Preferred compositions for carpet or upholstery cleaning or sanitizing include surfactant and, optionally, detergent builder and/or additional chelating or sequestering agent. In an embodiment, for carpet or upholstery cleaning or sanitizing, the composition includes as an additive one or more of alkalinity source, acidity source, cleaning enzyme, hardening agent, solubility modifier, detergent filler, defoamer, antimicrobial agent, a precipitation threshold agent or system, aesthetic enhancing agent, effervescent agent, activator for the active oxygen compound, or combinations thereof. Preferably, a carpet or upholstery cleaning or sanitizing composition includes as an additive one or more of source of alkalinity, cleaning enzyme, antimicrobial, activators for the active oxygen compound, or mixtures thereof. Preferably, a carpet or upholstery cleaning or sanitizing composition includes nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof. Preferably, a carpet or upholstery cleaning or sanitizing composition includes nonionic surfactant, aminocarboxylate, hydrogen peroxide adduct, C1-C6 carboxylic acid, alkali metal hydrogen carbonate, alkali metal hydrogen phosphate, alkali metal hydrogen sulfate, or combinations thereof. Preferably, a carpet or upholstery cleaning or sanitizing composition includes nonionic surfactant, aminocarboxylate, hydrogen peroxide adduct, polycarboxylate, alkali metal carbonate, or combinations thereof.

Preferred compositions for laundry cleaning or sanitizing include surfactant, builder, cleaning enzyme, alkalinity source, hardening agent, disintegrant, activator, or combinations thereof. In an embodiment, for laundry cleaning or sanitizing, the composition includes as an additive one or more of alkalinity source, cleaning enzyme, hardening agent, activator for the active oxygen compound, or combinations thereof. Preferably, a laundry cleaning or sanitizing composition includes nonionic surfactant, phosphonate, condensed phosphate, alkali metal hydrogen carbonate, or combinations thereof.

Salts

Some embodiments of the cleaning composition optionally include salt, or one or more additional salts, for example, alkali metal salt. The alkali metal salt can act as an alkalinity source to enhance cleaning of a substrate, and improve soil removal performance of the composition.

Additionally, in some embodiments the alkali metal salts can provide for the formation of an additional binder complex or binding agent including: alkali metal salt; organic sequestrant including a phosphonate, an aminocarboxylic acid, or mixtures thereof; and water. We refer to such binder complexes as “E-Form” hydrates. Such E-Form hydrates are discussed in detail in the following U.S. patents and patent applications: U.S. Pat. Nos. 6,177,392 B1; 6,150,324; and 6,156,715; and 6,258,765; each of which is incorporated herein by reference. The binding agent can include the organic sequestrant and the active oxygen compound. Preferably the binding agent has melting transition temperature in the range of about 120° C. to 160° C.

Some examples of alkali metal salts include alkali metal carbonates, silicates, phosphonates, sulfates, borates, or the like, and mixtures thereof. Alkali metal carbonates are more preferred, and some examples of preferred carbonate salts include alkali metal carbonates such as sodium or potassium carbonate, bicarbonate, sesquicarbonate, mixtures thereof, and the like; preferably sodium carbonate, potassium carbonate, or mixtures thereof.

In an embodiment, the active oxygen compound and the salt include a single preformed ingredient prior to addition to the mixture. Preferably, in such an embodiment, the active oxygen compound and the salt together include a hydrogen peroxide adduct. However, in a preferred version of such an embodiment, at least a portion of the salt is a separate ingredient from the active oxygen compound prior to addition to the mixture.

The composition can include in the range of 0 to about 80 wt-%, preferably about 15 to about 70 wt-% of an alkali metal salt, most preferably about 20 to about 60 wt-%.

Additionally, in some embodiments, salts, for example acidic salts, can be included as pH modifiers, sources of acidity, effervescing aids, or other like uses. Some examples of salts for use in such applications include sodium bisulfate, sodium acetate, sodium bicarbonate, citric acid salts, and the like and mixtures thereof. The composition can include in the range of 0.1 to 50% by weight such material. It should be understood that agents other than salts that act as pH modifiers, sources of acidity, effervescing aids, or like, can also be used in conjunction with the invention.

Chelating/Sequestering Agents

Other chelating/sequestering agents, in addition to the phosphonate or aminocarboxylic acid sequestrant discussed above, can be added to the composition and are useful for their sequestering properties. In general, a chelating/sequestering agent is a molecule capable of coordinating (i.e., binding) the metal ions commonly found in natural water to prevent the metal ions from interfering with the action of the other detersive ingredients of a cleaning composition. The chelating/sequestering agent may also function as a threshold agent when included in an effective amount. Preferably, a cleaning composition includes about 0.1-70 wt-%, preferably from about 5-60 wt-%, of a chelating/sequestering agent. Examples of chelating/sequestering agents include aminocarboxylic acids, condensed phosphates, polymeric polycarboxylates, and the like.

Useful aminocarboxylic acids include, for example, n-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), and the like.

Examples of condensed phosphates include sodium and potassium orthophosphate, sodium and potassium pyrophosphate, sodium and potassium tripolyphosphate, sodium hexametaphosphate, and the like. A condensed phosphate may also assist, to a limited extent, in solidification of the composition by fixing the free water present in the composition as water of hydration. Preferred compositions for carpet cleaning or sanitizing and for laundry cleaning or sanitizing include as a builder, chelator, or sequestrant a condensed phosphate, such as sodium tripolyphosphate.

The composition may include a phosphonate such as

1-hydroxyethane-1,1-diphosphonic acid CH₃C(OH)[PO(OH)₂]₂;

aminotri(methylenephosphonic acid) N[CH₂PO(OH)₂]₃; aminotri(methylenephosphonate), sodium salt,

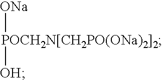

2-hydroxyethyliminobis(methylenephosphonic acid) HOCH₂CH₂N[CH₂PO(OH)₂]₂;

diethylenetriaminepenta(methylenephosphonic acid) (HO)₂POCH₂N[CH₂CH₂N[CH₂PO(OH)₂]₂]₂;

diethylenetriaminepenta(methylenephosphonate), sodium salt C₉H₍₂₈₋ₓ₎NₓNaₓO₁₅P₅ (x=7);

hexamethylenediamine(tetramethylenephosphonate), potassium salt C₁₀H₍₂₈₋ₓ₎N₂KₓO₁₂P₄ (x=6); bis(hexamethylene)triamine(pentamethylenephosphonic acid) (HO₂)POCH₂N[(CH₂)₆N[CH₂PO(OH)₂]₂]₂; and phosphorus acid H₃PO₃.

A preferred phosphonate combination is ATMP and DTPMP. A neutralized or alkaline phosphonate, or a combination of the phosphonate with an alkali source prior to being added into the mixture such that there is little or no heat or gas generated by a neutralization reaction when the phosphonate is added is preferred.

Polycarboxylates suitable for use as cleaning agents include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

In an embodiment, preferred organic sequestrants include amino tri(methylene phosphonic) acid, 1-hydroxyethylidene-1,1-diphosphonic acid, diethylenetriaminepenta(methylene phosphonic) acid, alanine-N,N-diacetic acid, diethylenetriaminepentaacetic acid, or alkali metal salts thereof, or mixtures thereof. In this embodiment, preferred alkali metal salts include sodium, potassium, calcium, magnesium, or mixtures thereof. The preferred organic sequestrant can include one or more of 1-hydroxyethylidene-1,1-diphosphonic acid; or diethylenetriaminepenta(methylene phosphonic) acid; or alanine-N,N-diacetic acid; or diethylenetriaminepentaacetic acid.

In a preferred embodiment, the organic sequestrant includes a mixture or blend including two or more organophosphonate compounds, or including two or more aminoacetate compounds, or including at least one organophosphonate and an aminoacetate compound.

Preferred compositions for carpet or upholstery cleaning or sanitizing include as chelating agent or sequestrant phosphonate, phosphate, aminocarboxylate, polycarboxylate, inorganic builder, salts thereof, combinations or mixtures thereof, and the like.

Preferred compositions for laundry cleaning or sanitizing include as chelating agent or sequestrant phosphonate, inorganic builder, EDTA, salts thereof, combinations or mixtures thereof, and the like.

Preferred mixtures of chelating agent or sequestrant include a mixture of aminocarboxylate (e.g., EDTA) and monomeric polycarboxylate (e.g., citric acid or citrate builder). Preferably, the aminocarboxylate and the polycarboxylate are selected to be and are employed at a concentration that is effective to stabilize an active oxygen compound, such as a peroxide, in a liquid composition. Preferably, the mixture of chelating agent or sequestrant is effective to stabilize active oxygen compound to the extent that at least about 50% of the active oxygen compound remains in a liquid composition after 24 hours at 120° F. Preferably, at least about 70% of the active oxygen compound remains in a liquid composition after 24 hours at 120° F. Preferably, the liquid composition includes about 0.01 to about 20 wt-% of the solid (e.g., powder) composition.

Preferred compositions for carpet or upholstery cleaning or sanitizing include as chelating agent or sequestrant condensed phosphate, phosphonate, aminocarboxylate, polycarboxylate, alkali metal carbonate, or mixtures thereof. Preferred condensed phosphates include sodium tripolyphosphate. Preferred compositions include as chelating agent or sequestrant aminocarboxylate (e.g., EDTA) and polycarboxylate (e.g., citric acid or alkali metal citrate salt). Such compositions can also include alkali metal carbonate, which can function, for example, as additional builder and/or alkalinity source. Preferred polycarboxylates include citric acid or citrate salt (e.g., alkali metal salt).

Preferred compositions for carpet or upholstery cleaning or sanitizing include as chelating agent or sequestrant water soluble compounds that do not contain phosphorus. Suitable water soluble compounds that do not contain phosphorus include aminocarboxylates and polycarboxylates. Preferred aminocarboxylates include nitrilotriacetic acid, EDTA, their alkali metal salts, and mixtures thereof. Preferred polycarboxylates include citric acid, its salts, and mixtures thereof. Preferably, the composition includes as builder nitrilotriacetate, citric acid, ethylene diamine tetraacetate, salt thereof, or mixture thereof.

Compositions Including Chelating Agent or Sequestrant

In certain embodiments, the solid composition includes about 10 to about 80 wt-% chelating agent or sequestrant; about 10 to about 40 wt-% chelating agent or sequestrant; about 10 to about 20 wt-% chelating agent or sequestrant; about 15 to about 55 wt-% chelating agent or sequestrant; about 15 to about 45 wt-% chelating agent or sequestrant; about 15 to about 25 wt-% chelating agent or sequestrant; about 20 to about 35 wt-% chelating agent or sequestrant; about 20 to about 30 wt-% chelating agent or sequestrant; about 25 to about 35 wt-% chelating agent or sequestrant; about 25 to about 30 wt-% chelating agent or sequestrant; about 30 to about 40 wt-% chelating agent or sequestrant; about 5 to about 30 wt-% chelating agent or sequestrant; or about 55 to about 95 wt-% chelating agent or sequestrant.

In certain embodiments, the solid composition includes about 20 to about 60 wt-% chelating agent or sequestrant; about 20 to about 40 wt-% chelating agent or sequestrant; about 20 to about 35 wt-% chelating agent or sequestrant; about 20 to about 30 wt-% chelating agent or sequestrant; about 25 to about 35 wt-% chelating agent or sequestrant; about 25 to about 30 wt-% chelating agent or sequestrant; about 30 to about 40 wt-% chelating agent or sequestrant; about 18 wt-% chelating agent or sequestrant; or about 20 wt-% chelating agent or sequestrant.

In certain embodiments, the solid composition includes about 5 to about 60 wt-% chelating agent or sequestrant; about 10 to about 50 wt-% chelating agent or sequestrant; about 10 to about 40 wt-% chelating agent or sequestrant; about 15 to about 40 wt-% chelating agent or sequestrant; about 20 to about 25 wt-% chelating agent or sequestrant; or about 22 wt-% chelating agent or sequestrant. In certain embodiments, the chelating agent or sequestrant in such a composition includes about 5 to about 95 wt-% polycarboxylic acid (e.g., citric acid); about 40 to about 90 wt-% polycarboxylic acid (e.g., citric acid); about 40 to about 70 wt-% polycarboxylic acid (e.g., citric acid); or about 60 wt-% polycarboxylic acid (e.g., citric acid). In certain embodiments, the chelating agent or sequestrant in such a composition includes about 5 to about 95 wt-% aminocarboxylate (e.g., EDTA); about 10 to about 40 wt-% aminocarboxylate (e.g., EDTA); about 30 to about 60 wt-% aminocarboxylate (e.g., EDTA); or about 40 wt-% aminocarboxylate (e.g., EDTA).

In certain embodiments, the solid composition includes as a lower limit about 5, about 40, or about 60 wt-% polycarboxylic acid (e.g., citric acid) to an upper limit of about 60, about 70, about 90, or about 95 wt-% polycarboxylic acid (e.g., citric acid), or each of these endpoints not modified by about. In certain embodiments, the solid composition includes as a lower limit about 5, about 10, about 30, or about 40 wt-% aminocarboxylate (e.g., EDTA) to an upper limit of about 40, about 60, or about 95 wt-% aminocarboxylate (e.g., EDTA), or each of these endpoints not modified by about.

In certain embodiments, the solid composition includes about 10 to about 50 wt-% chelating agent or sequestrant; about 10 to about 20 wt-% chelating agent or sequestrant; about 15 to about 30 wt-% chelating agent or sequestrant; about 20 to about 40 wt-% chelating agent or sequestrant; about 20 to about 25 wt-% chelating agent or sequestrant; about 25 to about 35 wt-% chelating agent or sequestrant; about 30 to about 50 wt-% chelating agent or sequestrant; about 15 wt-% chelating agent or sequestrant; about 20 wt-% chelating agent or sequestrant; about 25 wt-% chelating agent or sequestrant; about 30 wt-% chelating agent or sequestrant; about 35 wt-% chelating agent or sequestrant; or about 40 wt-% chelating agent or sequestrant.

In certain embodiments, the solid composition includes as a lower limit about 5, about 10, about 15, about 20, about 25, about 30, about 40, about 50, about 60, or about 70, wt-% chelating agent or sequestrant up to an upper limit of about 20, about 25, about 30, about 35, about 40, about 50, about 60, about 70, or about 80, or about 90 wt-% chelating agent or sequestrant, or each of these endpoints not modified by about. In certain embodiments, the solid composition includes about 10, about 15, about 20, about 25, about 30, about 35, about 40, about 45, about 50, about 65, or about 70 wt-% chelating agent or sequestrant, or any of these amounts not modified by about.

Alkalinity Sources

The cleaning composition produced according to the invention may include effective amounts of one or more inorganic detergents or alkaline sources to enhance cleaning of a substrate and improve soil removal performance of the composition. As discussed above, in embodiments including an alkali metal salt, such as alkali metal carbonate, the alkali metal salt can act as an alkalinity source. It should also be understood that in some embodiments, the active oxygen compound also can act as a source of alkalinity. The composition may include a secondary alkaline source separate from the active oxygen compound, and that secondary source can include about 0 to 75 wt-%, preferably about 0.1 to 70 wt-% of, in some embodiments, more preferably 1 to 25 wt-%, but in other embodiments, more preferably about 20 to 60 wt-%, or 30 to 70 wt-% of the total composition.

Additional alkalinity sources can include, for example, inorganic alkalinity sources, such as an alkali metal hydroxide or silicate, or the like. Suitable alkali metal hydroxides include, for example, sodium or potassium hydroxide. An alkali metal hydroxide may be added to the composition in a variety of forms, including for example in the form of solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt-% and a 73 wt-% solution.

Examples of useful alkaline metal silicates include sodium or potassium silicate (with a M₂O:SiO₂ ratio of 1:2.4 to 5:1, M representing an alkali metal) or metasilicate.

Other sources of alkalinity include a metal borate such as sodium or potassium borate, and the like; ethanolamines and amines; and other like alkaline sources.

Organic Surfactants or Cleaning Agents

The composition can include at least one cleaning agent which is preferably a surfactant or surfactant system. A variety of surfactants can be used in a cleaning composition, including anionic, nonionic, cationic, and zwitterionic surfactants, which are commercially available from a number of sources. Nonionic agents are preferred. For a discussion of surfactants, see Kirk-Othmer, Encyclopedia of Chemical Technology, Third Edition, volume 8, pages 900-912. Preferably, the cleaning composition includes a cleaning agent in an amount effective to provide a desired level of cleaning, preferably about 0-20 wt-%, more preferably about 1.5-15 wt-%.

Anionic surfactants useful in the present cleaning compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Preferred anionics are sodium alkylarylsulfonate, alpha-olefin sulfonate, and fatty alcohol sulfates.

Nonionic surfactants useful in cleaning compositions, include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC (BASF-Wyandotte), and the like; ethoxylated amines and ether amines commercially available from Tomah Corporation and other like nonionic compounds. Silicone surfactants such as the ABIL B8852 (Goldschmidt) can also be used.

Cationic surfactants useful for inclusion in a cleaning composition for fabric softening or for reducing the population of one or more microbes include amines such as primary, secondary and tertiary monoamines with C₆₋₂₄ alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C₆-C₂₄)dimethylbenzyl ammonium chloride, n-tetradecyldimethylbenzylammonium chloride monohydrate, a naphthalene-substituted quaternary ammonium chloride such as dimethyl-1-naphthylmethylammonium chloride, and the like; and other like cationic surfactants.

Surfactants or Cleaning Agents for Carpet or Upholstery Cleaning or Sanitizing

Suitable surfactants for cleaning or sanitizing compositions for carpet or upholstery include anionic, nonionic, and zwitterionic surfactants, which are commercially available from a number of sources. Many such surfactants are described hereinabove. Preferred surfactants include nonionic surfactants. Preferred nonionic surfactants for carpet or upholstery cleaning or sanitizing include low foaming nonionic surfactants. Although, higher foaming nonionic surfactants can be employed in the compositions and methods of the present invention.

Examples of preferred, low foaming, nonionic surfactants include secondary ethoxylates, such as those sold under the trade name TERGITOL™, such as TERGITOL™ 15-S-7 (Union Carbide), Tergitol 15-S-3, Tergitol 15-S-9 and the like. Other preferred classes of low foaming nonionic surfactant include alkyl or benzyl-capped polyoxyalkylene derivatives and polyoxyethylene/polyoxypropylene copolymers.

Compositions for carpet or upholstery cleaning or sanitizing preferably include a low foam surfactant such as a nonionic surfactant or a combination of an anionic surfactant with a defoamer. An amphoteric surfactant can be employed for carpet or upholstery cleaning or sanitizing compositions, but such surfactants typically produce undesirably high levels of foam. Compositions for carpet or upholstery cleaning or sanitizing preferably do not employ a cationic surfactant, use of which can void warranties provided by certain carpet or upholstery manufacturers, which is believed to be due to their action as an attractant for anionic soils.

Usually, solid or agglomerate cleaning compositions for carpet or upholstery cleaning according to the present invention will contain no more than about 25 wt-% surfactant, preferably about 0.1-20 wt-%, preferably about 1.5-15 wt-%, preferably 0.1 to about 10 wt-% surfactant, and most preferably 0.1 to about 5 wt-% surfactant. Use dilutions of these concentrates preferably contain no more than about 10 wt-% surfactant, more preferably 0.1 to about 5 wt-% surfactant, and most preferably 0.1 to about 2 wt-%.

Surfactants or Cleaning Agents for Laundry Sanitizing

Suitable surfactants for cleaning or sanitizing compositions for carpet or upholstery include anionic, nonionic, cationic, and zwitterionic surfactants, which are commercially available from a number of sources. Many such surfactants are described hereinabove. Preferred surfactants include nonionic surfactants. Preferred nonionic surfactants for laundry cleaning or sanitizing include alkyl phenol ethoxylates, linear and secondary alcohol ethoxylates, ethoxy/propoxy block surfactants, and polyether siloxanes. For laundry applications, surfactants and their levels can be selected to provide increased dispensing rate.

Examples of preferred nonionic surfactants include EO/PO block nonionic surfactant terminated in PO, silicone nonionic surfactant, benzyl ether of a polyethoxylated primary alcohol, nonylphenol ethoxylate (e.g., nonylphenol 9.5 mole ethoxylate), sodium linear alkyl benzene sulfonate (C₁₂), and the like.

Usually, compositions for laundry cleaning or sanitizing according to the present invention will contain no more than about 50 wt-% surfactant, preferably about 30 wt-%, preferably about 10 wt-% surfactant. Use dilutions of these concentrates preferably contain no more than about 0.5 wt-% surfactant, preferably 0.3 wt-% surfactant, preferably 0.1 wt-%.

Solid Compositions Including Surfactant

In certain embodiments, the solid composition includes about 1 to about 30 wt-% surfactant; about 1 to about 15 wt-% surfactant; about 1 to about 5 wt-% surfactant; about 1 to about 4 wt-% surfactant; about 1 to about 3 wt-% surfactant; about 4 to about 15 wt-% surfactant; about 6 to about 10 wt-% surfactant; about 7 to about 11 wt-% surfactant; or about 8 to about 10 wt-% surfactant. In certain embodiments, the solid composition includes about 1 to about 11 wt-% surfactant; about 1 to about 5 wt-% surfactant; about 1 to about 3 wt-% surfactant; about 5 to about 11 wt-% surfactant; about 6 to about 10 wt-% surfactant; about 7 to about 11 wt-% surfactant; about 8 to about 10 wt-% surfactant; or about 8 wt-% surfactant. In certain embodiments, the solid composition includes about 1 to about 15 wt-% surfactant; about 5 to about 15 wt-% surfactant; about 5 to about 10 wt-% surfactant; or about 7 wt-% surfactant.

In certain embodiments, the solid composition includes about 5 to about 50 wt-% surfactant; about 10 to about 40 wt-% surfactant; about 20 to about 40 wt-% surfactant; about 10 to about 20 wt-% surfactant; about 30 to about 50 wt-% surfactant; about 15 wt-% surfactant; about 30 wt-% surfactant; or about 40 wt-% surfactant.

In certain embodiments, the solid composition includes as a lower limit about 1, about 2, about 3, about 4, about 5, about 6, about 7, about 8, about 10, about 15, about 20, about 25, or about 30 wt-% surfactant up to an upper limit of about 2, about 3, about 4, about 5, about 6, about 7, about 8, about 10, about 11, about 15, about 20, about 25, about 40, or about 50 wt-% surfactant, or each of these endpoints not modified by about. In certain embodiments, the solid composition includes about 1, about 2, about 3, about 4, about 5, about 6, about 7, about 8, about 9, or about 10, about 11, about 15, about 20, about 25, or about 30 wt-% surfactant, or any of these amounts not modified by about.

Antimicrobials

Antimicrobial agents are chemical compositions that can be used in a solid functional material that alone, or in combination with other components, act to reduce or prevent microbial contamination and deterioration of commercial products material systems, surfaces, etc. In some aspects, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

It should also be understood that the active oxygen compounds used in the formation of compositions embodying the invention also act as antimicrobial agents, and can even provide sanitizing activity. In fact, in some embodiments, the ability of the active oxygen compound to act as an antimicrobial agent reduces the need for secondary antimicrobial agents within the composition. For example, percarbonate compositions have been demonstrated to provide excellent antimicrobial action (Example 4 hereinbelow). Nonetheless, some embodiments incorporate additional antimicrobial agents.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents are typically formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their anti-microbial properties. In some embodiments, an antimicrobial component, such as TAED can be included in the range of 0.001 to 75% by wt. of the composition, preferably 0.01 to 20, and more preferably 0.05 to 10% by wt of the composition.

Compositions formulated for carpet or upholstery cleaning or sanitizing can include phenyl or benzyl benzoate can also be included in the compositions of or employed in the present invention as an agent against micro-insects that inhabit carpet or upholstery, such as dust mites.

If present in compositions formulated for carpet or upholstery cleaning or sanitizing, the additional antimicrobial agent preferably is 0.01 to about 30 wt-% of the composition, preferably 0.05 to about 10 wt-% and most preferably about 0.1 to about 5 wt-%. In a use solution the additional antimicrobial agent preferably is 0.001 to about 5 wt-% of the composition, preferably 0.01 to about 2 wt-%, and preferably 0.05 to about 0.5 wt-%.

Activators

In some embodiments, the antimicrobial activity or bleaching activity of the composition can be enhanced by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine; transition metal; compound that includes carboxylic, nitrile, amine, or ester moiety; or mixtures thereof.

In some embodiments, an activator component can include in the range of 0.001 to 75% by wt. of the composition, preferably 0.01 to 20, and more preferably 0.05 to 10% by wt of the composition.

In an embodiment, the activator for the active oxygen compound combines with the active oxygen to form an antimicrobial agent.

The solid composition typically remains stable even in the presence of activator of the active oxygen compound. In many compositions would be expected to react with and destabilize or change the form of the active oxygen compound. In contrast, in an embodiment of the present invention, the composition remains solid; it does not swell, crack, or enlarge as it would if the active oxygen compound were reacting with the activator.

In an embodiment, the composition includes a solid block, and an activator material for the active oxygen is coupled to the solid block. The activator can be coupled to the solid block by any of a variety of methods for coupling one solid cleaning composition to another. For example, the activator can be in the form of a solid that is bound, affixed, glued or otherwise adhered to the solid block. Alternatively, the solid activator can be formed around and encasing the block. By way of further example, the solid activator can be coupled to the solid block by the container or package for the cleaning composition, such as by a plastic or shrink wrap or film.

For laundry cleaning or sanitizing compositions, preferred activators include TAED, sodium nonanonyloxybenzene sulfonate (NOBS), acetyl caprolactones, and sodium nonanonyloxybenzene sulfonate at 1-10 wt-%.

Rinse Aid Functional Materials

Functional materials of the invention can include a formulated rinse aid composition containing a wetting or sheeting agent combined with other optional ingredients in a solid made using the complex of the invention. The rinse aid component of the present invention can include a water soluble or dispersible low foaming organic material capable of reducing the surface tension of the rinse water to promote sheeting action and to prevent spotting or streaking caused by beaded water after rinsing is completed. This is often used in warewashing processes. Such sheeting agents are typically organic surfactant-like materials having a characteristic cloud point. The cloud point of the surfactant rinse or sheeting agent is defined as the temperature at which a 1 wt-% aqueous solution of the surfactant turns cloudy when warmed.

There are two general types of rinse cycles in commercial warewashing machines, a first type generally considered a sanitizing rinse cycle uses rinse water at a temperature of about 180° F., about 80° C. or higher. A second type of non-sanitizing machines uses a lower temperature non-sanitizing rinse, typically at a temperature of about 125° F., about 50° C. or higher. Surfactants useful in these applications are aqueous rinses having a cloud point greater than the available hot service water. Accordingly, the lowest useful cloud point measured for the surfactants of the invention is approximately 40° C. The cloud point can also be 60° C. or higher, 70° C. or higher, 80° C. or higher, etc., depending on the use locus hot water temperature and the temperature and type of rinse cycle.

Preferred sheeting agents, typically include a polyether compound prepared from ethylene oxide, propylene oxide, or a mixture in a homopolymer or block or heteric copolymer structure. Such polyether compounds are known as polyalkylene oxide polymers, polyoxyalkylene polymers or polyalkylene glycol polymers. Such sheeting agents require a region of relative hydrophobicity and a region of relative hydrophilicity to provide surfactant properties to the molecule. Such sheeting agents have a molecular weight in the range of about 500 to 15,000. Certain types of (PO)(EO) polymeric rinse aids have been found to be useful containing at least one block of poly(PO) and at least one block of poly(EO) in the polymer molecule. Additional blocks of poly(EO), poly PO or random polymerized regions can be formed in the molecule.

Particularly useful polyoxypropylene polyoxyethylene block copolymers are those including a center block of polyoxypropylene units and blocks of polyoxyethylene units to each side of the center block. Such polymers have the formula shown below:

(EO)ₙ—(PO)ₘ-(EO)ₙ

wherein n is an integer of 20 to 60, each end is independently an integer of 10 to 130. Another useful block copolymer are block copolymers having a center block of polyoxyethylene units and blocks of polyoxypropylene to each side of the center block. Such copolymers have the formula:

(PO)ₙ-(EO)ₘ—(PO)ₙ

wherein m is an integer of 15 to 175 and each end are independently integers of about 10 to 30. The solid functional materials of the invention can often use a hydrotrope to aid in maintaining the solubility of sheeting or wetting agents. Hydrotropes can be used to modify the aqueous solution creating increased solubility for the organic material. Preferred hydrotropes are low molecular weight aromatic sulfonate materials such as xylene sulfonates and dialkyldiphenyl oxide sulfonate materials.

In an embodiment, compositions according to the present invention provide desirable rinsing properties in ware washing without employing a separate rinse agent in the rinse cycle. For example, good rinsing occurs using such compositions in the wash cycle when rinsing employs just soft water.

Additional Bleaching Agents

Additional bleaching agents for use in inventive formulations for lightening or whitening a substrate, include bleaching compounds capable of liberating an active halogen species, such as Cl₂, Br₂, I₂, ClO₂, BrO₂, IO₂, —OCl⁻, —OBr⁻ and/or, —OI⁻, under conditions typically encountered during the cleansing process. Suitable bleaching agents for use in the present cleaning compositions include, for example, chlorine-containing compounds such as a chlorite, a hypochlorite, chloramine. Preferred halogen-releasing compounds include the alkali metal dichloroisocyanurates, chlorinated trisodium phosphate, the alkali metal hypochlorites, alkali metal chlorites, monochloramine and dichloramine, and the like, and mixtures thereof. Encapsulated chlorine sources may also be used to enhance the stability of the chlorine source in the composition (see, for example, U.S. Pat. Nos. 4,618,914 and 4,830,773, the disclosure of which is incorporated by reference herein). A bleaching agent may also be an additional peroxygen or active oxygen source such as hydrogen peroxide, perborates, for example sodium perborate mono and tetrahydrate, sodium carbonate peroxyhydrate, phosphate peroxyhydrates, and potassium permonosulfate, with and without activators such as tetraacetylethylene diamine, and the like, as discussed above. A cleaning composition may include a minor but effective additional amount of a bleaching agent above that already available from the stabilized active oxygen compound, preferably about 0. 1-10 wt-%, preferably about 1-6 wt-%.

Secondary Hardening Agents/Solubility Modifiers.

The present compositions may include a minor but effective amount of a secondary hardening agent, as for example, an amide such stearic monoethanolamide or lauric diethanolamide, or an alkylamide, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the cleaning agent and/or other active ingredients may be dispensed from the solid composition over an extended period of time. The composition may include a secondary hardening agent in an amount of about 5-20 wt-%, preferably about 10-15 wt-%.

For laundry cleaning or sanitizing compositions, preferred secondary modifying agents include polyethylene glycol or a mixture of tripolyphosphate, stearic monoethanolamide, and EO/PO block polymer. PEG can be present at up to about 30 wt-%. The mixture of tripolyphosphate, stearic monoethanolamide, and EO/PO block polymer can be present at up to about 20 wt-%.

Detergent Fillers

A cleaning composition may include an effective amount of one or more of a detergent filler which does not perform as a cleaning agent per se, but cooperates with the cleaning agent to enhance the overall processability of the composition. Examples of fillers suitable for use in the present cleaning compositions include sodium sulfate, sodium chloride, starch, sugars, C₁-C₁₀ alkylene glycols such as propylene glycol, and the like. A filler such as a sugar (e.g. sucrose) can aid dissolution of a solid composition by acting as a disintegrant. Preferably, a detergent filler is included in an amount of about 1-20 wt-%, preferably about 3-15 wt-%.

Defoaming Agents

An effective amount of a defoaming agent for reducing the stability of foam may also be included in the present cleaning compositions. Preferably, the cleaning composition includes about 0.0001-5 wt-% of a defoaming agent, preferably about 0.01-3 wt-%.

Examples of defoaming agents suitable for use in the present compositions include silicone compounds such as silica dispersed in polydimethylsiloxane, EO/PO block copolymers, alcohol alkoxylates, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like. A discussion of defoaming agents may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated by reference herein. Preferred defoamers for carpet or upholstery cleaning include polysiloxanes.

For laundry cleaning or sanitizing compositions, preferred defoamers include silicone compounds such as siloxanes.

Anti-Redeposition Agents

A cleaning composition may also include an anti-redeposition agent capable of facilitating sustained suspension of soils in a cleaning solution and preventing the removed soils from being redeposited onto the substrate being cleaned. Examples of suitable anti-redeposition agents include fatty acid amides, fluorocarbon surfactants, complex phosphate esters, styrene maleic anhydride copolymers, and cellulosic derivatives such as hydroxyethyl cellulose, hydroxypropyl cellulose, and the like. A cleaning composition may include about 0.5-10 wt-%, preferably about 1-5 wt-%, of an anti-redeposition agent.

For laundry cleaning or sanitizing compositions, preferred antiredeposition agents include styrene maleic anhydride copolymers, sodium tripolyphosphate, sodium carboxymethyl cellulose, polyvinylpyrrolidone, and acrylic acid polymers. These can be employed at use concentrations of about 3 to about 15 ppm, and formulated in solids to achieve such use concentrations.

Optical Brighteners

Optical brightener is also referred to as fluorescent whitening agents or fluorescent brightening agents provide optical compensation for the yellow cast in fabric substrates. With optical brighteners yellowing is replaced by light emitted from optical brighteners present in the area commensurate in scope with yellow color. The violet to blue light supplied by the optical brighteners combines with other light reflected from the location to provide a substantially complete or enhanced bright white appearance. This additional light is produced by the brightener through fluorescence. Optical brighteners absorb light in the ultraviolet range 275 through 400 nm. and emit light in the ultraviolet blue spectrum 400-500 nm.

Fluorescent compounds belonging to the optical brightener family are typically aromatic or aromatic heterocyclic materials often containing condensed ring system. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.). The choice of optical brighteners for use in detergent compositions will depend upon a number of factors, such as the type of detergent, the nature of other components present in the detergent composition, the temperature of the wash water, the degree of agitation, and the ratio of the material washed to the tub size. The brightener selection is also dependent upon the type of material to be cleaned, e.g., cottons, synthetics, etc. Since most laundry detergent products are used to clean a variety of fabrics, the detergent compositions should contain a mixture of brighteners which are effective for a variety of fabrics. It is of course necessary that the individual components of such a brightener mixture be compatible.

Optical brighteners useful in the present invention are commercially available and will be appreciated by those skilled in the art. Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents”, M. Zahradnik, Published by John Wiley & Sons, New York (1982), the disclosure of which is incorporated herein by reference.

Stilbene derivatives which may be useful in the present invention include, but are not necessarily limited to, derivatives of bis(triazinyl)amino-stilbene; bisacylamino derivatives of stilbene; triazole derivatives of stilbene; oxadiazole derivatives of stilbene; oxazole derivatives of stilbene; and styryl derivatives of stilbene.

For laundry cleaning or sanitizing compositions, preferred optical brighteners include stilbene derivatives, which can be employed at concentrations of up to 1 wt-%.

Dyes/Odorants

Various dyes, odorants including perfumes, and other aesthetic enhancing agents may also be included in the composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in the compositions include, for example, terpenoids such as citronellol, aldehydes such as amyl cinnamaldehyde, a jasmine such as C1S jasmine or jasmal, vanillin, and the like.

For laundry cleaning or sanitizing compositions, preferred dyes and odorants include one or more blue dyes, which can be employed at concentrations up to about 0.1 wt-%.

Aqueous Medium

The ingredients may optionally be processed in a minor but effective amount of an aqueous medium such as water to achieve a mixture, to aid in the solidification, to provide an effective level of viscosity for processing the mixture, and to provide the processed composition with the desired amount of firmness and cohesion during discharge and upon hardening. In a preferred embodiment, the water serves as a processing medium and also forms part of the binding agent, as described hereinabove. The mixture during processing typically includes about 0.2-12 wt-% of an aqueous medium, preferably about 0.5-10 wt-%.

Constituent Concentrations

Some examples of representative constituent concentrations for base components of some compositions embodying the invention can be found in Table 2, in which the values are given in wt-% of the ingredients in reference to the total composition weight.

TABLE 2

| | Preferred wt-% | More Preferred wt-% |
|---|---|---|
| Component | Range | Range |
| Organic Sequestrant: | 1-20 | 1.5-10 |
| Active Oxygen Compound | 1-70 | 5-60 |
| Other additives | 0-90 | 10-80 |
| Water | 5-20 | 7-15 |

Some preferred embodiments include the constituent concentrations for base components as found in Table 3A, wherein the values are given in wt-% of the ingredients in reference to the total composition weight.

TABLE 3A

| | | More Preferred wt-% |
|---|---|---|
| Component | Preferred wt-% Range | Range |
| Organic Sequestrant | 1-20 | 1.5-10 |
| Sodium Percarbonate | 1-70 | 5-60 |
| Water | 5-20 | 7-15 |
| Other additives | 0-90 | 10-80 |

Some examples of carpet or upholstery cleaning or sanitizing compositions according to or employed in the methods of the present invention can be found in Table 3B, in which the values are given in wt-% of the ingredients in reference to the total composition weight.

TABLE 3B
Preferred Compositions for Carpet or Upholstery Cleaning or Sanitizing

| | Preferred wt-% | Preferred wt-% | | |
|---|---|---|---|---|
| Component | Range | Range | Preferred wt-% Range | Preferred wt-% |
| Active Oxygen | 40-80 | 50-70 | 50-65 | 60 |
| Compound | | | | |
| Organic | 15-50 | 25-40 | 25-30 | 25 |
| Sequestrant plus | | | | |
| Optional | | | | |
| Builder | | | | |
| Water | 0-10 | 0-5 | 0 | 0 |
| Surfactant | 4-15 | 7-11 | 8-10 | 9 |
| Other Additives | 0-25 | 0-18 | 0-10 | 0-10 |

Additional preferred compositions for carpet or upholstery cleaning or sanitizing include the ranges of ingredients listed in Table 3C.

TABLE 3C
Additional Preferred Compositions for Carpet or
Upholstery Cleaning or Sanitizing

| | Preferred wt-% | Preferred wt-% | Preferred wt-% |
|---|---|---|---|
| Component | Range | Range | Range |
| Active Oxygen | 50-70 | 30-50 | 50-80 |
| Compound | | | |
| Organic | 20-35 | 30-60 | 30-60 |
| Sequestrant plus | | | |
| Optional | | | |
| Builder | | | |
| Water | 0-5 | 0-5 | 0-5 |
| Surfactant | 7-11 | 1-15 | 1-15 |
| Other Additives | | 0-10 | 0-10 |

Additional preferred compositions include the ranges of ingredients listed in Table 3D.

TABLE 3D
Additional Preferred Compositions for
Carpet or Upholstery Cleaning and Sanitizing.

| | Preferred wt-% | Preferred wt-% | Preferred wt-% | Preferred wt-% |
|---|---|---|---|---|
| Component | Range | Range | Range | Range |
| Active Oxygen | 30-80 | 40-70 | 50-60 | 55 |
| Compound | | | | |
| Organic | 5-60 | 10-40 | 20-25 | 22 |
| Sequestrant plus | (5-95:95-5) | (40-90:60-10) | (40-70:60-30) | (60:40) |
| Optional | | | | |
| Builder | | | | |
| (ratio | | | | |
| polycarboxylic | | | | |
| acid: | | | | |
| aminocarboxylate) | | | | |
| Surfactant | 1-15 | 5-15 | 5-10 | 7 |
| Water | 0-10 | 0-5 | 0 | 0 |

Additional preferred compositions include the ranges of ingredients listed in Table 5.

TABLE 3E
Additional Preferred Compositions for Carpet
or Upholstery Cleaning and Sanitizing.

| | Preferred wt-% | Preferred wt-% | Preferred wt-% | Preferred wt-% |
|---|---|---|---|---|
| Component | Range | Range | Range | Range |
| Active Oxygen | 5-60 | 25-60 | 50-60 | 55 |
| Compound | | | | |
| Alkalinity | 10-50 | 10-35 | 15-20 | 18 |
| Source | | | | |
| Organic | 10-50 | 15-40 | 20-25 | 22 |
| Sequestrant plus | (5-95:95-5) | (40-90:60-10) | (40-70:60-30) | (60:40) |
| Optional | | | | |
| Builder | | | | |
| (ratio | | | | |
| polycarboxylic | | | | |
| acid: | | | | |
| aminocarboxylate) | | | | |
| Surfactant | 1-15 | 5-15 | 5-10 | 7 |
| Water | 0-10 | 0-5 | 0 | 0 |

The compositions described in Tables 3D and 3E preferably stabilize active oxygen compound in a liquid composition, such as a liquid use or concentrate composition. Compositions including a combination of builders have been determined to stabilize active oxygen compounds in liquid compositions. Stabilizing active oxygen compound includes providing higher concentrations of active oxygen compound for longer times compared to control compositions. Active oxygen compound concentrations can be measured as total peroxide in a liquid composition. Preferred compositions for stabilizing active oxygen compound include polycarboxylic acid (e.g., citric acid) and aminocarboxylate (e.g., EDTA) as builder.

Some examples of laundry cleaning or sanitizing compositions according to or employed in the methods of the present invention can be found in Table 3F, in which the values are given in wt-% of the ingredients in reference to the total composition weight.

TABLE 3F
Preferred Compositions for Laundry Cleaning or Sanitizing

| | Preferred wt-% | Preferred wt-% | Preferred wt-% | Preferred wt-% |
|---|---|---|---|---|
| Component | Range | Range | Range | Range |
| Active Oxygen | 5-60 | 10-25 | 30-40 | 50-60 |
| Compound | | | | |
| Organic | 0-15 | 0-15 | 5-15 | 5-15 |
| Sequestrant | | | | |
| Water | 0-10 | 1-9 | 1-9 | 1-9 |
| Surfactant | 5-50 | 10-40 | 10-40 | 10-40 |
| Other Additives | | | | |

TABLE 3G
Preferred Compositions for Laundry Cleaning or Sanitizing

| | Preferred | Preferred | Preferred | Preferred |
|---|---|---|---|---|
| Component | wt-% Range | wt-% Range | wt-% Range | wt-% |
| Active Oxygen | 10-20 | 14-16 | 10-20 | 10-20 |
| Compound | | | | |
| Organic | 5-10 | 7-8 | 5-10 | 5-10 |
| Sequestrant | | | | |
| Water | 5-15 | 7-11 | 5-15 | 5-15 |
| Surfactant | 2-40 | 20-30 | 15-30 | 10-35 |
| Other | | | | |
| Additives | | | | |

TABLE 3H
Preferred Compositions for Laundry Cleaning or Sanitizing

| | Preferred | Preferred | Preferred | Preferred |
|---|---|---|---|---|
| Component | wt-% Range | wt-% Range | wt-% Range | wt-% |
| Active Oxygen | 5-60 | 5-30 | 10-20 | 20-50 |
| Compound | | | | |
| Organic | 1-10 | 5-10 | 6-8 | 5-8 |
| Sequestrant | | | | |
| Water | 0-10 | 0-5 | 0-15 | |
| Surfactant | 1-30 | 10-30 | 15-30 | 15-20 |

Solid or aggregate compositions and methods embodying the invention are suitable for preparing a variety of solid cleaning compositions, as for example, a cast, extruded, molded or formed solid pellet, block, tablet, powder, granule, flake, and the like, or the formed solid or aggregate can thereafter be ground or formed into a powder, granule, flake, and the like. The solid compositions provide for a stabilized source of active oxygen or oxygen bleaching agents. Additionally, such compositions can include additional functional materials, as discussed above.

Solid compositions embodying the invention can be used in a broad variety of cleaning and destaining applications. Some examples include machine and manual warewashing, presoaks, laundry and textile cleaning and destaining, carpet cleaning and destaining, surface cleaning and destaining, kitchen and bath cleaning and destaining, floor cleaning and destaining, cleaning in place operations, general purpose cleaning and destaining, and the like.

Processing of the Composition

In another respect, the invention includes a method of processing a solid cleaning composition. Effective amounts of ingredients, some in granular or powder forms and some in liquid forms, and optional other ingredients, are mixed. A minimal amount of heat may be applied from an external source to facilitate processing of the mixture.

In some embodiments, a mixing system provides for continuous mixing of the ingredients at high shear to form a substantially homogeneous liquid or semi-solid mixture in which the ingredients are distributed throughout its mass. Preferably, the mixing system includes means for mixing the ingredients to provide shear effective for maintaining the mixture at a flowable consistency, with a viscosity during processing of greater than about 1000 cP, preferably in the range of about 1,000-1,000,000 cP, more preferably in the range of about 50,000-200,000 cP. The mixing system is preferably a continuous flow mixer or more preferably, a single or twin screw extruder apparatus, with a twin-screw extruder being highly preferred. Those of skill in the art will recognize other suitable mixing systems.

The mixture is typically processed at a temperature to maintain the physical and chemical stability of the ingredients, preferably at temperatures in the range of about ambient to 80° C., more preferably in the range of about 25-55° C. Although limited external heat may be applied to the mixture, the temperature achieved by the mixture may become elevated during processing due to friction, variances in ambient conditions, and/or by an exothermic reaction between ingredients. Optionally, the temperature of the mixture may be increased, for example, at the inlets or outlets of the mixing system.

An ingredient may be in the form of a liquid or a solid such as a dry particulate, and may be added to the mixture separately or as part of a premix with another ingredient, as for example, the cleaning agent, the aqueous medium, and additional ingredients such as a second cleaning agent, a detergent adjuvant, an antimicrobial agent, or other additive, a secondary hardening agent, and the like. One or more premixes may be added to the mixture.

The ingredients are mixed to form a substantially homogeneous consistency wherein the ingredients are distributed substantially evenly throughout the mass. In some embodiments, the mixture is then discharged from the mixing system through a die or other shaping means. The profiled extrudate then can be divided into useful sizes with a controlled mass. Preferably, the extruded solid is packaged in film. The temperature of the mixture when discharged from the mixing system is preferably sufficiently low to enable the mixture to be cast or extruded directly into a packaging system without first cooling the mixture. The time between extrusion discharge and packaging may be adjusted to allow the hardening of the detergent block for better handling during further processing and packaging. Preferably, the mixture at the point of discharge is in the range of about 20-90° C., preferably in the range of about 25-55° C. The composition is then allowed to harden to a solid form that may range from a low density, sponge-like, malleable, caulky consistency to a high density, fused solid, concrete-like block.

Optionally, heating and cooling devices may be mounted adjacent to mixing apparatus to apply or remove heat in order to obtain a desired temperature profile in the mixer. For example, an external source of heat may be applied to one or more barrel sections of the mixer, such as the ingredient inlet section, the final outlet section, and the like, to increase fluidity of the mixture during processing. Preferably, the temperature of the mixture during processing, including at the discharge port, is maintained preferably in the range of about 20-90° C.

When processing of the ingredients is completed, the mixture may be discharged from the mixer through a discharge die. The composition eventually hardens due to the chemical reaction of the ingredients forming the binder. The solidification process may last from a few minutes to about six hours, depending, for example, on the size of the cast, molded or extruded composition, the ingredients of the composition, the temperature of the composition, and other like factors. Preferably, the cast, molded or extruded composition “sets up” or begins to hardens to a solid form within about 1 minute to about 3 hours, preferably about 1 minute to about 2 hours, preferably about 1 minute to about 20 minutes.

The present compositions can be extruded by, for example, mixing the ingredients or premixes in order, and dispensing the mixed composition into a container. The composition can then solidify in the container. The mixed composition can also be pressed into tablets. Extruded blocks typically maintain their shape and solidify in a short period of time, typically within about five minutes or less. The blocks typically exhibit no notable post extrusion cracking or deformation, and maintain long term (for example, greater than one and a half years) solid stability and available oxygen stability.

It will be understood by those of skill in the art and others that while certain processing techniques, for example, extrusion techniques may be preferred in certain embodiments, other processing techniques are contemplated for use in other embodiments. For example, a broad variety of mixing, forming, casting, molding, extruding, and other such techniques may be used to form the solid composition in accordance with other embodiments of the invention.

Packaging System

In some embodiments, the solid composition can be packaged. The packaging receptacle or container may be rigid or flexible, and composed of any material suitable for containing the compositions produced according to the invention, as for example glass, metal, plastic film or sheet, cardboard, cardboard composites, paper, and the like.

Advantageously, since the composition is processed at or near ambient temperatures, the temperature of the processed mixture is low enough so that the mixture may be cast, molded or extruded directly into the container or other packaging system without structurally damaging the material. As a result, a wider variety of materials may be used to manufacture the container than those used for compositions that processed and dispensed under molten conditions.

Preferred packaging used to contain the compositions is manufactured from a flexible, easy opening film material.

Dispensing of the Processed Compositions

The cleaning composition made according to the present invention can be dispensed in any suitable method generally known. Preferably, the cleaning composition is dispensed from a spray-type dispenser such as that disclosed in U.S. Pat. Nos. 4,826,661, 4,690,305, 4,687,121, 4,426,362 and in U.S. Pat. Nos. Re 32,763 and 32,818, the disclosures of which are incorporated by reference herein. Briefly, a spray-type dispenser functions by impinging a water spray upon an exposed surface of the solid composition to dissolve a portion of the composition, and then immediately directing the concentrate solution including the composition out of the dispenser to a storage reservoir or directly to a point of use. When used, the product is removed from the package (e.g.) film and is inserted into the dispenser. The spray of water can be made by a nozzle in a shape that conforms to the solid shape. The dispenser enclosure can also closely fit the detergent shape in a dispensing system that prevents the introduction and dispensing of an incorrect detergent. The aqueous concentrate is generally directed to a use locus.

As discussed above, in some embodiments, the solid composition can include activators within the composition that react with the active oxygen to form an activated component. It is also contemplated that in some embodiments, the active oxygen can be activated in-situ, during dispensing or during use by contact with an activating material. For example, it is contemplated that portions of the dispensing system, such as a reservoir or dispensing wand, would include activating material, such as transition metals, or other activators as discussed above. As the use solution is created or dispensed, activation would occur through contact with the activator material.

In some embodiments, the compositions hereof will preferably be formulated such that during use in aqueous cleaning operations the wash water will have a pH of between about 1 and about 14, preferably between about 6.5 and about 11, most preferably between 7-10.5. Techniques for controlling pH at recommended usage levels include the use of buffers, alkali, acids, etc., and are well known to those skilled in the art.

Methods Employing the Present Compositions

It is contemplated that the cleaning compositions of the invention can be used in a broad variety of industrial, household, vehicle care, and other such applications. Some examples include surface disinfectant, ware cleaning, laundry cleaning, laundry cleaning or sanitizing, vehicle cleaning, floor cleaning, surface cleaning, pre-soaks, clean in place, and a broad variety of other such applications.

Methods of Carpet or Upholstery Cleaning and Sanitizing

The present compositions can be employed for cleaning and/or sanitizing carpets, rugs, and other floor coverings and/or upholstery made from fiber, yarn, fabric, or other textiles. The compositions are suitable for cleaning or sanitizing any carpet, floor covering, or upholstery that can be cleaned by conventional methods or apparatus, provided those methods or apparatus can employ a solid or agglomerate cleaning composition or a liquid cleaning composition made from a solid or agglomerate cleaning composition. Applying the composition can be accomplished or followed by direction of a liquid stream or mist onto the carpet or upholstery, optionally rubbing and/or brushing the carpet or upholstery and, optionally, removing the composition from the carpet or upholstery, e.g., by blotting, rubbing, or vacuuming.

The compositions for the cleaning of carpet or upholstery according to the present invention can be used both for manual carpet or upholstery cleaning and carpet or upholstery cleaning machines. For carpet or upholstery cleaning machines the solid or agglomerate compositions can be mixed with liquid, typically water, to form a liquid use composition, typically an aqueous preparation. The liquid use composition or aqueous preparation can be formed by dissolving or mixing to achieve the desired concentration of product. Typically, compositions to be used in carpet or upholstery cleaning machines are formulated to be low foaming. The compositions of the present invention can be employed with any of a variety of carpet or upholstery cleaning machines. For example, the present use compositions can be applied by a carpet or upholstery cleaning machine that optionally heats the use composition, sprays it onto the carpet or upholstery, optionally brushes the carpet or upholstery, and vacuums up excess liquid. Alternatively, the present use compositions can be applied with a sprayer and rubbed or brushed into the carpet or upholstery with a rotating brush carpet or upholstery cleaning machine and the excess liquid removed by vacuum or blotting.

Liquid use compositions made from solid or agglomerate compositions according to the present invention can be applied directly onto the area to be treated or applied using a cloth, a sprayer, an aerosol can, a sponge, a brush, or another mechanical or electrical device (e.g. extractor, steam cleaner, etc.). In a preferred embodiment of the invention a liquid use composition is applied to the area to be treated by using a carpet extractor such as is available through a variety of commercial vendors. Such extractors spray a liquid use composition onto the area to be treated and optionally brush the surface and extract excess liquid from the surface via vacuum. In a preferred embodiment of the invention a liquid use composition is applied to the area to be treated and a rotary bonnet cleaning machine used to agitate the surface with excess liquid optionally vacuumed-up afterwards. In a preferred embodiment a liquid use composition is sprayed onto the surface which is then rubbed or brushed by hand and the excess liquid optionally removed by blotting or vacuum. A sprayer can be trigger operated, pump operated, electrically operated, or operated by any source of pressurized gas such as a can or a pressurizer. Typically, a sprayer uniformly covers the area to be treated.

Advantageously, cleaning action of the present compositions begins as soon as the compositions are applied onto the carpet or upholstery. Rubbing and/or brushing are not required for the cleaning process. However, mechanical action is useful to allow the liquid use composition to more quickly penetrate thick carpet or upholstery. Preferably, however, for highly soiled carpet or upholstery or in high traffic areas of carpet the present method for carpet or upholstery cleaning includes applying a the cleaning composition and then rubbing and/or brushing more or less intensively, for example with a sponge, brush, or other mechanical or electrical device, optionally with the aid of water. Typically the time spent rubbing or brushing is between 1 second to a few minutes per square meter. After applying the cleaning composition, and rubbing or brushing (if any), the composition is removed from the carpet or upholstery, preferably by mechanical means including brushing out and/or vacuuming up the excess liquid or dried composition.

The compositions for carpet or upholstery cleaning according to the present invention are preferably applied to the carpet or upholstery to be cleaned as a liquid use composition (e.g., an aqueous preparation). Typically, the user makes the liquid use composition by mixing the solid or agglomerate carpet or upholstery cleaning composition with water, or another carrier. Use compositions typically include about 0.1 to about 20 wt-%, about 0.1 to about 10 wt-%, about 0.1 to about 5 wt-%, or 0.5% to about 3 wt-% of the solid or agglomerate carpet or upholstery cleaning composition. The amount or concentration of the compositions employed for carpet or upholstery cleaning according to the present invention can depend on the severity of the stain or soil. In the case of stubborn stains, more than one application can be used to ensure complete removal of the stain.

However, the compositions herein are particularly useful in that for heavily soil areas it is often not necessary to pre-spot or pre-spray the area before cleaning, resulting in a significant reduction in labor over the present standard practice of pre-spotting stains followed by pre-spraying heavily soiled areas followed by extracting the entire surface. Indeed, the carpet or upholstery cleaning compositions herein are particularly suitable to remove dinginess from carpet or upholstery that results from a diffuse layer of soil and/or from general wear. In an embodiment of the present method, a liquid cleaning composition made from the present solid or agglomerate carpet or upholstery cleaning compositions can be left to dry on the carpet to dry residue which is less likely to attract dirt than a sticky residue. The powdery residue can then optionally be removed from the carpet or upholstery mechanically.

In another embodiment, the present compositions are applied as granular or powder compositions. Such compositions for carpet or upholstery cleaning of can be applied directly onto the area of the carpet or upholstery to be treated by, for example, sprinkling the composition over the area or using a sponge, a brush, or other mechanical or electrical device, preferably in presence of water.

The area to be treated employing compositions according to the present invention can be any size. For example, the present methods and compositions can be employed for cleaning all or part of a carpet or upholstery, even for removing individual spots.

According to the present invention the compositions herein can be used for the removal of stains and soils from carpets or upholstery as well as of odors. Removing stains from carpets or upholstery typically includes lightening the stain's color, preferably lightening the stain so that it is not or is only slightly visible to the human eye as well as mechanically removing the lightened soil from the surface. Stains can bleached by commercial available products called carpet brighteners which are typically just a bleaching agent such as sodium percarbonate. The sodium percarbonate alone is able to bleach the stain and reduce its intensity in color. However the soil that comprises the stain remains in place on the surface unless a bleaching and cleaning composition such as is described herein is used. Removing stains can be accomplished by applying a carpet or upholstery cleaning composition described herein to the stained area of the carpet or upholstery using the previously described methods. The amount of destaining is graded visually.

In addition the compositions according to the present invention can be used to sanitizer carpets and reduce the level of micro-insects such as dust mites in carpet or upholstery.

Liquid Use Compositions

As described herein above, liquid use compositions can be formed by mixing the solid or agglomerate cleaning composition with a liquid carrier. Preferably, the liquid is water and the liquid use composition is an aqueous preparation. Liquid use compositions can include about 0.1 to about 20 wt-% of the solid or agglomerate carpet or upholstery cleaning composition, preferably about 0.1 to about 10 wt-% of the solid or agglomerate carpet or upholstery cleaning composition, preferably about 0.1 to about 5 wt-% of the solid or agglomerate carpet or upholstery cleaning composition, most preferably about 0.5% to about 3 wt-% of the solid or agglomerate carpet or upholstery cleaning composition. Therefore, the liquid use compositions of or employed in the present invention can include the ranges or amounts of ingredients employed in the solid or agglomerate compositions multiplied, for example, by 0.1%, by 0.5%, by 3%, by 5%, by 10%, by 20%, or by any value within the ranges recited for liquid use compositions.

Preferred liquid use compositions (e.g., aqueous preparations) include about 0.1 to about 10 wt-% of the solid or agglomerate cleaning composition, and have a pH of about 7 to about 11. Preferably, the pH is about 9 to about 10, preferably, less than 10. Preferred liquid use compositions (e.g., aqueous preparations) include about 0.2 to about 9 wt-% active oxygen compound; about 0.005 to about 1.1 wt-% surfactant; and about 0.1 to about 6 wt-% organic sequestrant and builder; and have a pH of about 7 to about 11. Preferably, this pH is about 9 to about 10, preferably less than 10. Preferred liquid use compositions (e.g., aqueous preparations) include about 0.4 to about 0.9 wt-% active oxygen compound; about 0.01 to about 0.11 wt-% surfactant; and about 0.2 to about 0.6 wt-% organic sequestrant and builder. These preferred liquid use compositions can have a pH of about 9 to about 10, preferably less than 10.

The liquid use composition can include, for example, about 0.5 to about 0.8 wt-% sodium percarbonate; about 0.01 to about 0.2 wt-% alcohol ethoxylate, alkylbenzene sulfonate, or mixtures thereof; and about 0.2 to about 0.4 wt-% non-phosphate builder, preferably in an aqueous preparation. In certain embodiments, such an aqueous preparation has a pH of about 7 to about 11, of about 9 to about 10, or less than 10.

Preferably, the liquid use composition includes a mixture of builders effective to stabilize active oxygen compound in the liquid use composition. That is, the mixture of builders forms a liquid use composition in which the active oxygen compound remains at a higher concentration for a longer time than in a liquid use composition lacking that combination and/or quantity of builders. Preferably, a liquid use composition according to the present invention includes active oxygen compound stabilized to the extent that at least about 50% of the active oxygen compound remains in a liquid composition after 24 hours at 120° F. Preferably, at least about 70% of the active oxygen compound remains in the liquid composition after 24 hours at 120° F. Preferably, such a stabilized liquid composition includes about 0.01 to about 20 wt-% of the solid (e.g., powder) cleaning composition.

Methods of Laundry Cleaning and Sanitizing

The present compositions can be employed for cleaning and/or sanitizing laundry using any of the processes and apparatus conventionally used for laundry cleaning and sanitizing. For example the present compositions and methods can be used for or include hand wash, machine wash, presoak, home laundry, commercial laundry, or the like.

A method for laundering soiled fabrics can include contacting soiled fabric with an aqueous washing solution formed from an effective amount of the laundry cleaning compositions according to the present invention. Contacting of fabrics with washing solution will generally occur under conditions of agitation. Agitation can be provided by a washing machine for good cleaning. Washing can be followed by drying the wet fabric in a conventional clothes dryer.

The present laundry cleaning compositions can also be used to pretreat soiled fabrics, for example stained fabrics, before washing. Pretreating can include application of concentrated forms of the present cleaning compositions directly onto the soiled or stained fabric. Pretreating contact can be conducted for a period of from about 30 seconds to 24 hours, typically immediately before washing. Preferably, pretreatment times will range from about 3 to about 15 minutes.

For laundry cleaning or sanitizing the solid or agglomerate compositions can be mixed with liquid, typically water, to form a liquid use composition, typically an aqueous preparation. The liquid use composition or aqueous preparation can be formed by dissolving or mixing to achieve the desired concentration of product. Typically, compositions to be used in laundry machines are formulated to be low foaming.

The compositions for laundry cleaning or sanitizing according to the present invention are preferably applied to the laundry as a liquid use composition (e.g., an aqueous preparation). Typically, for home use, the user makes the liquid use composition by mixing the solid or laundry cleaning composition with water, or another carrier. For commercial use, typically, the laundry cleaning composition is dispensed from a conventional automatic dispenser suitable for dispensing solid cleaners. Use compositions typically include about 0.01 to about 3 wt-%, about 0.3 to about 1 wt-%, or about 0.1 to about 0.3 wt-% of the solid or agglomerate cleaning composition. The amount or concentration of the compositions employed for laundry cleaning or sanitizing according to the present invention can depend on the severity of the stain or soil.

According to the present invention the compositions herein can be used for the removal of stains and soils from laundry as well as of odors. Removing stains from laundry typically includes lightening the stain's color, preferably lightening the stain so that it is not or is only slightly visible to the human eye as well as mechanically removing the lightened soil from the surface.

The present invention can be better understood with reference to the following examples. These examples are intended to be representative of specific embodiments of the invention, and are not intended as limiting the scope of the invention.

### EXAMPLES

### Example 1

### Carpet Cleaning and Sanitizing Employing the Methods and Compositions of the Present Invention

A solid (e.g., powder) or agglomerate carpet cleaning composition according to the present invention was formulated and tested for carpet sanitizing and stain removal.

Materials and Methods

A powdered test sanitizing composition was prepared by mixing ingredients together to achieve:

| Ingredient | Wt-% |
|---|---|
| Phosphonate, ATMP | 11 |
| Nonionic surfactant; C12, C15 | 9 |
| ethoxylate with 7EO | |
| Builder, Sodium Tripolyphosphate | 20 |
| Active Oxygen Compound, | 60 |
| Sodium Percarbonate | |

1.75 grams of this composition was diluted in 100 mL of water for use as in the following carpet sanitizer test method.

Carpet Sanitizer Test Method

A composition according to the present invention was tested for carpet sanitizing activity using a method provided by the Environmental Protection Agency (see, for example, DIS/TSS-8/Apr. 18, 1981, EFFICACY DATA REQUIREMENTS, Carpet Sanitizers, the disclosure of which is incorporated herein by reference).

For this method, samples of two types of carpets were used, one made of nylon and another made of olefin. Each type of carpet was cut into 8×12-in pieces and six 2×2 inch squares were cut from the backing side of the carpet, with the squares at least 4 in apart on center. Each carpet sample had its pile surface covered with aluminum foil, which was folded over edges to secure. The covered carpet was then steam sterilized and dried. Samples for further testing were determined to be free of residual bacteriostatic activity on the pile or backing. The carpet was mounted on a board.

Diluted standardized bacterial stock suspensions were applied to the 2×2 squares of carpet. The bacterial stock suspensions included Staphylococcus aureus ATCC 6538, Enterobacter aerogenes ATCC 13048, or Pseudomonas aeruginosa ATCC 15442. Each square was inoculated with 0.1 ml of the bacterial suspension having a concentration 10×10 bacteria per ml in phosphate buffer dilution water. The inoculated carpet was dried at 35-37° C. for 60 min with the foil wrap loosely in place.

Test sanitizer compositions and control compositions were uniformly applied to selected 2×2 carpet squares by spraying followed by brushing with a brush dipped in the appropriate composition. 20 mL of each composition was applied to each 2×2 sample of carpet. Portions of the carpet not having a composition applied were protected with the foil wrapping. The amount of sanitizing composition added was chosen for comparison to amounts that would be applied during actual in-place carpet sanitizing. The treated carpet remained at room temperature for 60 min for partial drying of the treated areas.

Following the 60-min drying, each 2×2-in square was cut free with flamed forceps and knife. Each square was transferred to a separate extraction bottle of neutralizer broth, which was then shaken vigorously for at least 1 min to free the bacteria from the carpet fibers. Reductions in bacteria due to sanitizing composition were determined by comparing the number of survivors from each treated test square against the average viable count from the scrubbed control squares. A reduction of at least 3-log was required for sanitizing activity.

Carpet Stain Removal Test

Carpet was stained with coffee or wine by pouring 20 mL of the material onto the carpet and allowing it to dry and cure for 2-3 days. The stained carpet was treated with a 0.5 wt % aqueous dilution of a composition according to the present invention, and also two commercial carpet spotters, one acidic and one basic. Treating included wetting the stained carpet with the composition or spotter, agitating the wetted area, and blotting away liquid with a paper towel. After the treated spots air dried overnight, they were compared for destaining and graded. Slight change in staining intensity that was mostly a color change was graded 1. A moderate reduction in intensity plus a color change was graded 2. Nearly complete reduction in staining with very little stain remaining was graded 3.

Results

The test composition caused a more than 3-log reduction in bacterial population against S. aureus, E. coli, and Ps. aeruginosa in the carpet sanitizer test. The present compositions make effective carpet sanitizers.

The test composition was also effectively removed stains from carpet. These results are shown in Table 4 below.

TABLE 4
Carpet Stain Removal by a Composition
According to the Present Invention

| | Activity Against | Activity Against |
|---|---|---|
| Treatment | Coffee Stain | Wine Stain |
| Composition of the Present | 3 | 3 |
| Invention | | |
| Commercial Acidic Carpet | 2 | 2 |
| Spotter | | |
| Commercial Basic Carpet | 1 | 1 |
| Spotter | | |

Activity graded as: 1 = only a slight change in staining intensity that was mostly a color change; 2 = a moderate reduction in intensity plus a color change; and 3 = nearly a complete reduction in staining with very little stain remaining.

### Example 2

### Carpet Cleaning Field Test Employing the Methods and Compositions of the Present Invention

A solid (e.g., powder) or agglomerate carpet cleaning composition according to the present invention was used to clean a carpet in a conference room at a shopping mall in Bloomington, Minn.

Materials and Methods

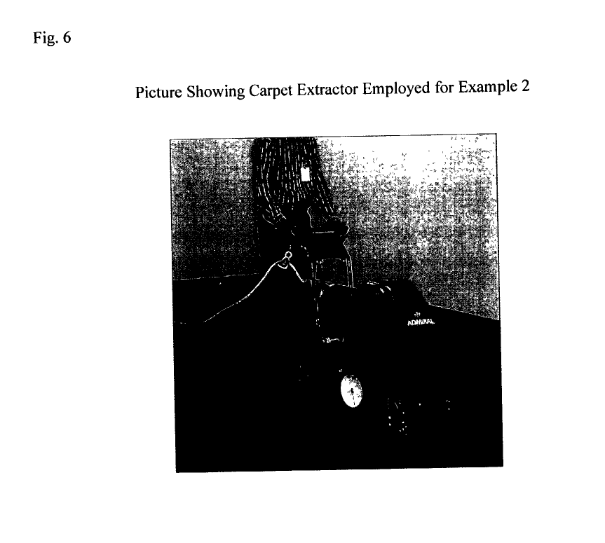

The composition of Example 1 was used dissolved in water at 1.0 wt-% and was applied with a commercial carpet extractor. FIG. 6 shows the extractor and operator.

For comparison purposes, a commercial liquid carpet cleaner was employed at the use concentration recommended on its label, a concentration of about 0.4 wt-% in water. The commercial liquid carpet cleaner included surfactant and builder, but not active oxygen compound.

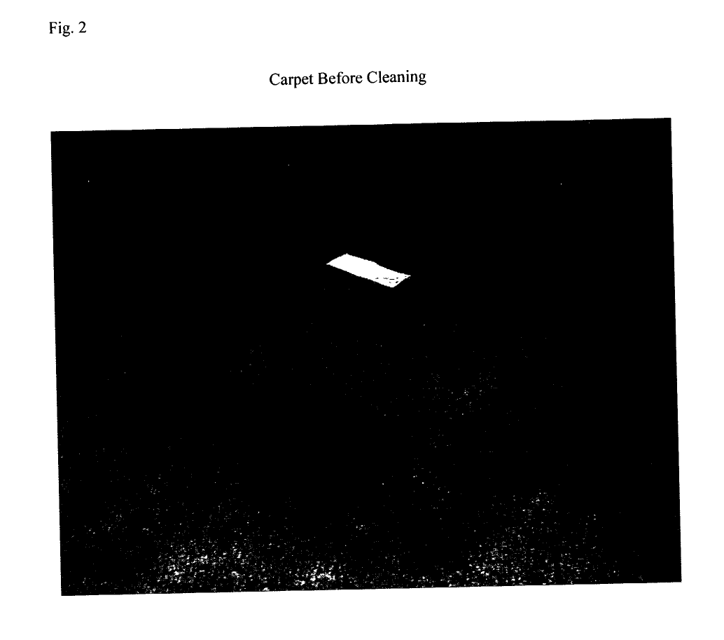

The carpet in the conference room was heavily stained and soiled, as shown in FIG. 2. The partial rings on the carpet in the foreground are about the size of the bottom of a 5 gallon pail and appear to have been made by the content of a such a pail containing some foodstuff (FIG. 2).

Results

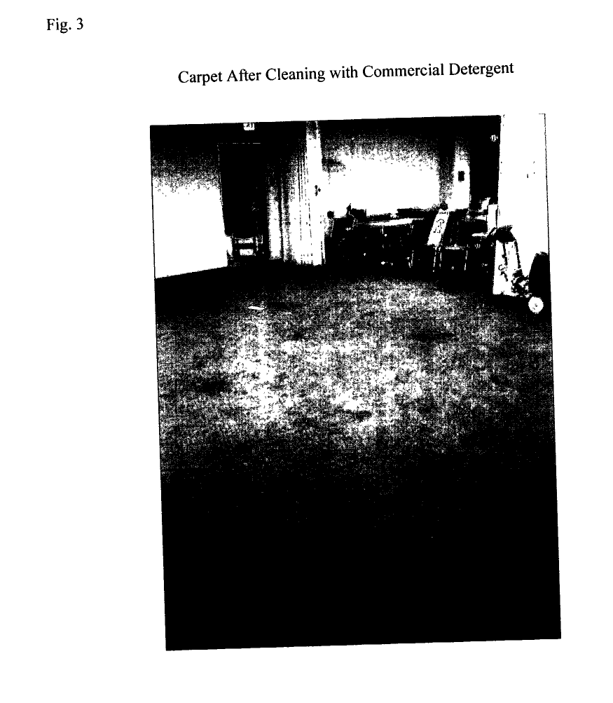

FIG. 2 shows the carpet before cleaning and is notable for the heavy degree of stain and soil. FIG. 3 shows the carpet after cleaning with the commercial detergent. The commercially cleaned carpet still shows numerous stains, for example several at the center of the photograph and one near the white paper towel near top center.

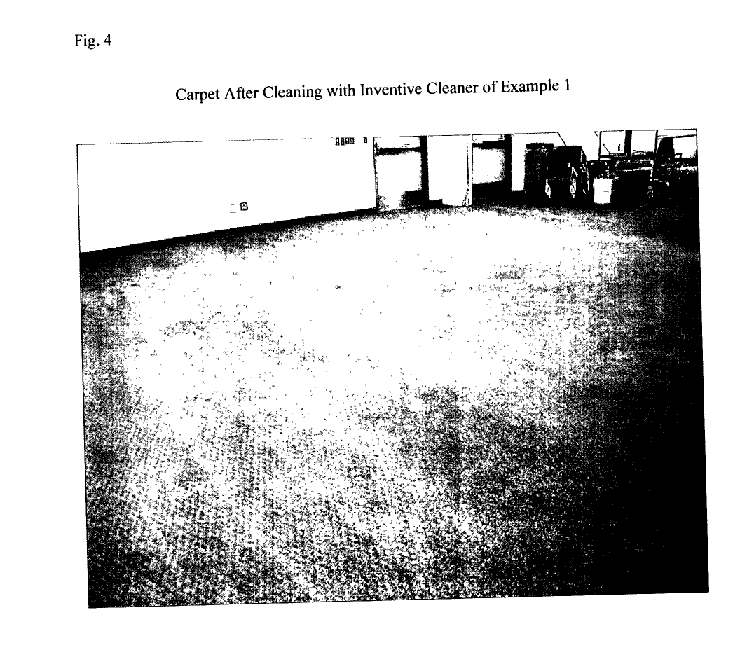

FIG. 4 shows the carpet after cleaning with the inventive composition and method. The carpet is sufficiently clean to show foot prints that have pressed the nap at the top of the photograph. The carpet cleaned by an inventive method and composition shows little or no staining.

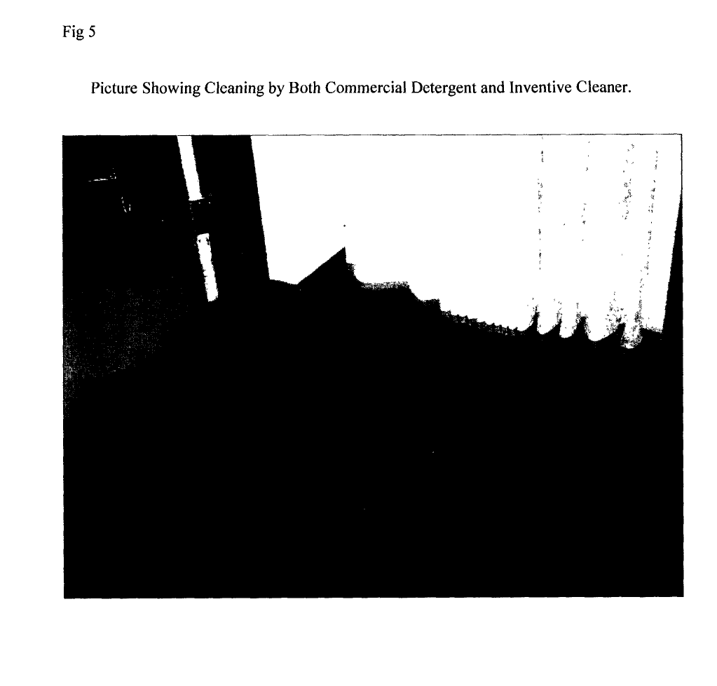

FIG. 5 illustrates the shortcomings of the commercial detergent compared to an inventive method and composition. The majority of the carpet shown in this Figure remains heavily soiled after cleaning with the commercial detergent. The small portion of carpet shown under the curtain was cleaned with an inventive method and composition. This small portion is much lighter due to substantial soil and stain removal.

### Example 3

### Carpet Sanitizing and Cleaning Employing Non-Phosphate Compositions of the Present Invention

A solid (e.g., powder) or agglomerate carpet cleaning composition according to the present invention was formulated and tested for carpet sanitizing and stain removal.

Materials and Methods

A powdered cleaning and sanitizing composition was prepared by blending together the components shown below.

| Ingredient | Wt-% |
|---|---|
| Sequestrant, Tetrasodium EDTA | 8.6 |
| Nonionic surfactant; C12, C15 | 8.1 |
| ethoxylate with 7EO | |
| Builder, Sodium Carbonate | 18.4 |
| pH modifier, citric acid | 12.3 |
| Active Oxygen Compound, | 52.6 |
| Sodium Percarbonate | |

Stain removal by this composition was tested by methods similar to those employed in Example 1 below, but employing motor oil as an additional staining soil. Briefly, a 1% solution of the non-phosphate cleaning composition was tested for the removal of coffee, wine, and dirty motor oil stains from white carpet using a small hand-held carpet extractor.

Results

Stain removal was found to be comparable to the phosphate formula described in Example 1. That is, for each stain, this non-phosphate composition caused nearly a complete reduction in staining with very little stain remaining.

### Example 4

### Stabilization of Active Oxygen Compounds by Compositions of the Present Invention

A solid (e.g., powder) or agglomerate carpet cleaning composition according to the present invention was formulated and tested for stabilization of active oxygen compounds.

Materials and Methods

A solid composition was prepared by blending together the components shown below.

| | Fixed | Variable |
|---|---|---|
| Ingredient | Wt-% | Wt-% |
| Builder, Tetrasodium EDTA | 9 | 0-22 |
| Builder, Citric Acid | 13 | 0-22 |
| Nonionic surfactant; | 7 | 7 |
| Sodium Carbonate | 18 | 18 |
| Active Oxygen Compound, | 53 | 53 |
| Sodium Percarbonate | | |

This powder composition was dissolved in water at 1 wt-% and active oxygen compound was subsequently determined as peroxide. Peroxide was determined by titration with potassium permanganate according to well known procedures.

Results

Liquid compositions of the “fixed” formula were made at a concentration of 1 wt-% in deionized water and tap water and stored at room temperature. The level of peroxide was measured and remained steady for up to 8 days after the liquid composition was made.

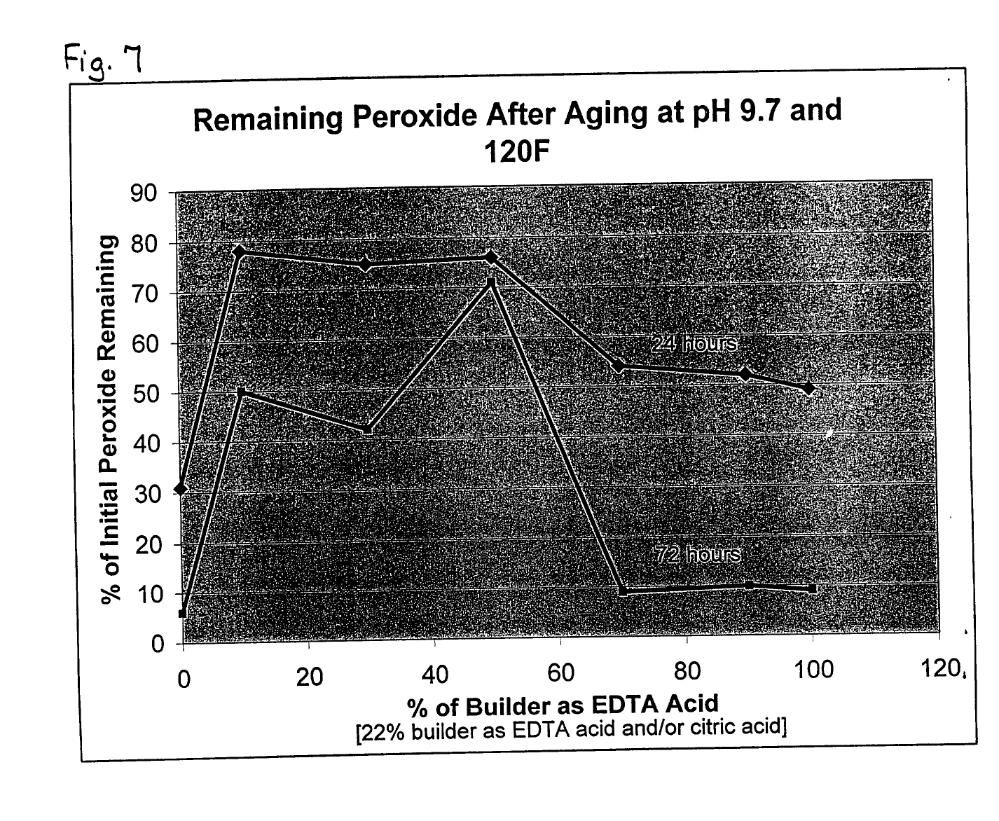

Liquid compositions of the “variable” formula were made at a concentration of 1 wt-% and heated to 120° F. for up to 72 hours. The results of this test are shown in FIG. 7. In this test, the active oxygen compound (measured as peroxide) was stable for 24 hours at 120° F. with builder including 5 to 95 wt-% aminocarboxylate and 5 to 95 wt-% polycarboxylic acid. The active oxygen compound exhibited greater stability for 24 hours at 120° F. with builder including 10 to 90 wt-% aminocarboxylate and 10 to 90 wt-% polycarboxylic acid, and even greater stability with builder including 10 to 60 wt-% aminocarboxylate and 40 to 90 wt-% polycarboxylic acid. The active oxygen compound (measured as peroxide) was stable for 72 hours at 120° F. with builder including 10 to 60 wt-% aminocarboxylate and 40 to 90 wt-% polycarboxylic acid.

### Example 5

### Solid Laundry Cleaners and Sanitizers

Formula 1

Formula 1 was made with composition shown below:

| | |
|---|---|
| Raw Material | Percentage |

| | | |
|---|---|---|
| Water | 7.7% | 3.0% |
| Nonylphenol ethoxylate 9.5 | 15.4% | 6.0% |
| Polyethylene glycol 8000 | 76.9% | 30.0% |
| Premix: | 100% | 39.0% |
| Soda ash (grade 100) | | 8.5% |
| Sucrose | | 5.0% |
| Sodium tripolyphosphate | | 32.5% |
| (hydrate) | | |
| Sodium Perborate | | 15.0% |
| | | 100% |

Formula 1 was made by preparing a premix of NPE 9.5, PEG 8000, and water with heating. Soda ash, sucrose, tripolyphosphate, and sodium perborate were then added. Formula 1 was prepared as a solid that exhibited a dispense rate of 68 g/min (Solitron, 3.9 nozzle, 20 psi, 100° F.). This stable solid had a pH of 9.9 at a concentration of 90 g per 10 gallons of tap water.

The wash and bleach performance of Formula 1 was determined by using swatches with various soils, such as olive oil, dust, sebum, mineral oil, dirty motor oil, blood, wine, make up (e.g., lipstick), a blood/milk/ink mixture, tea, curry, or strawberry. The results of these wash and bleach performance tests are reported in Table 5. In this table the percentages refer to % soil removal based on diffuse reflective light intensity. A formula for used for calculating such percentages was % soil removal=(L_{final}−Lᵢₙᵢₜᵢₐₗ)/(92−Lᵢₙᵢₜᵢₐₗ), in which L is diffuse reflective light intensity measured with a Hunter diffuse reflectance spectrophotometer.

TABLE 5
Wash and Bleach Performance of Formula 1:

| | |
|---|---|
| Soil removal (hospitality): | 30% |
| Soil removal (general) | 40% |
| Removable of bleachable stains: | 6% |

The antibacterial activity of Formula 1 was determined by standard methods for determining bacteria kill in vitro. The log population reductions from these antibacterial tests are reported in Table 6.

TABLE 6
Antibacterial Activity of Formula 1.

| | |
|---|---|
| Pseudomonas aeruginosa: | >5 log/30 sec |
| | >6 log/5 min |
| Staphylococcus aureus: | >1 log/30 sec |
| | >2 log/5 min |
| 105° F., 0.2% Formula 1 | |

Formula 2

Formula 2 was made with the composition shown below:

| | |
|---|---|
| Raw Material | Percentage |

| | | |
|---|---|---|
| Water | 7.7% | 3.0% |
| Nonylphenol ethoxylate 9.5 | 15.4% | 6.0% |
| Polyethylene glycol 8000 | 76.9% | 30.0% |
| Premix: | 100% | 39.0% |
| Soda ash (grade 100) | | 8.5% |
| Sucrose | | 5.0% |
| Sodium tripolyphosphate (hydrate) | | 27.5% |
| Sodium Perborate | | 15.0% |
| TAED | | 5.0% |
| | | 100% |

Solid Formula 2 was made by generally the same method employed for Formula 1, with TAED added last at 120° F. This solid exhibited 18% decomposition in 3 weeks at room temperature when CMC coated TAED was used.

The wash and bleach performance of Formula 2 was determined by the methods described for Formula 1. The results of these wash and bleach performance tests are reported in Table 7. Comparing Formulas 1 and 2 indicates that addition of 5% of TAED improves wash and bleach performance by up to 5% (e.g. on soil such as tea, lipstick). Addition of TAED to sodium perborate in a 3:1 ratio improves the antimicrobial efficacy of perborate substantially compared to Formula 1.

TABLE 7
Wash and Bleach Performance of Formula 2:

| | |
|---|---|
| Soil removal (hospitality): | 30% |
| Soil removal (general) | 40% |
| Removable of bleachable stains: | 8.8% |

Formula 3

Formula 3 was made with the composition shown below:

| Raw Material | Percentage | | |
|---|---|---|---|
| Sodium hydroxide (50%) | 5.31% | | |
| Briquest 301* | 7.17% | | |
| Phoenix powder premix** | 18.56% | | |
| Sodium LAS flakes | 2.86% | | |
| Purafect 4000L Protease | 0.95% | | |
| Tergitol | 11.42% | | |
| Sodium Percarbonate | 18.73% | 35.00% | 53.73% |
| Soda ash (dense) | 35.00% | 18.73% | 0.00% |
| | 100% | 100% | 100% |

*Briquest 301 is a 50-% aqueous solution of amino tri(methylenephosphonic acid) commercially available from Albright & Wilson.
**Phoenix powder premix is a mixture sodium tripolyphosphate (granular, 94.275%), ethoxy-propoxy block nonionic surfactant terminated with PO (3.573%), stearic monoethanolamide (0.581%), and polyether siloxane surfactant (1.571%).

Solid Formula 3 was made by mixing the several ingredients. This stable solid had a pH of about 10.3 when dissolved at 90 g per 10 gallons of tap water.

The wash and bleach performance of Formula 3 was determined by the methods described for Formula 1. The results of these wash and bleach performance tests are reported in Table 8.

TABLE 8
Wash and Bleach Performance of Formula 3:

| | | | |
|---|---|---|---|
| Removal of bleachable stains: | 10% | 15% | 16% |

| | | |
|---|---|---|
| | | (with increasing |
| | | percarbonate content) |
| Soil removal (hospitality): | 37% | |
| Soil removal (general): | 34% | |

The antibacterial activity of Formula 3 was determined by the methods described above for Formula 1. The log population reductions from these antibacterial tests are reported in Table 9.

TABLE 9
Antibacterial Activity of Formula 3.
Formula with 8.9% Tergitol and 15% percarbonate:

| | |
|---|---|
| Pseudomonas aeruginosa: | >5 log/30 sec |
| | >6 log/5 min |
| Staphylococcus aureus: | >1.4 log/30 sec |
| | >4.3 log/5 min |
| 105° F., 0.2% Formula 1 | |
| At 120° F.: | >6 log reduction |
| | for both bacteria. |

Formula 4

Formula 4 was made with the composition shown below:

| Raw Material | Percentage | | |
|---|---|---|---|
| Sodium hydroxide (50%) | 5.31% | | |
| Briquest 301* | 7.17% | | |
| Phoenix powder premix** | 13.56% | | |
| Sodium LAS flakes | 2.86% | | |
| Purafect 4000L Protease | 0.95% | | |
| Tergitol | 11.42% | | |
| TAED | 5.00% | | |
| Sodium Percarbonate | 18.73% | 35.00% | 53.73% |
| Soda ash (dense) | 35.00% | 18.73% | 0.00% |
| | 100% | 100% | 100% |

* and ** as described above for Formula 3

Solid Formula 4 was made by mixing the several ingredients. This stable solid had a pH of about 10.3 when dissolved at 90 g per 10 gallons of tap water.

The wash and bleach performance of Formula 3 was determined by the methods described for Formula 1. The results of these wash and bleach performance tests are reported in Table 10. Addition of TAED to sodium percarbonate substantially improves the antimicrobial efficacy compared to formula 3.

TABLE 10
Wash and Bleach Performance of Formula 4:

| Removal of bleachable stains | |
|---|---|
| (120° F.): | |
| 15% percarbonate/5% TAED: | 10% (ave. of tea, curry, strawberry) |
| Soil removal (hospitality): | 37% |
| Soil removal (general): | 34% |

Formula 5

Formula 5 was made with the composition shown below:

| Raw Material | Percentage |
|---|---|
| Linear alcohol ethoxylate 5 EO | 13.0% |
| Linear alcohol ethoxylate 7 EO | 25.0% |
| Sodium LAS flakes | 1.0% |
| Harmony soap (sodium salts of | 1.0% |
| Tallow fatty acids) | |
| Phosphate ester | 1.0% |
| Sodium tripolyphosphate (powder) | 38.0% |
| Sodium metalsilicate | 5.0% |
| Soda ash (light) | 6.0% |
| Sodium perborate monohydrate | 10.0% |

A paste of Formula 5 was made by mixing the several ingredients. This paste had rest viscosity of 100,000 Pa sec, yield stress of 1 Pa, flow viscosity of 500 Pas sec, and a dispense rate of 200-300 g/min, and was stable in an oven at 120° F.

The antibacterial activity of Formula 5 was determined by the methods described above for Formula 1. The log population reductions from these antibacterial tests are reported in Table 11.

TABLE 11
Antibacterial Activity of Formula 5.

| | |
|---|---|
| Klebsiella pneumoniae | >3 log reduction/10 min |
| Staphylococcus aureus | >3 log reduction/10 min |
| 120° F., 0.5% use concentration | |

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A solid or agglomerated cleaning composition comprising a solidified mixture of:
an organic sequestrant comprising phosphonate, aminocarboxylate, or mixtures thereof;
active oxygen compound comprising peroxygen moiety; and
water;
wherein the combined moles of peroxygen moiety and water in the mixture are greater than the number of moles of active oxygen compound.

2. The composition of claim 1, comprising less than 8 moles of active oxygen compound for each mole of organic sequestrant.

3. The composition of claim 1, comprising 5 to 15 moles of water for each mole of organic sequestrant.

4. The composition of claim 1, wherein the active oxygen compound comprises inorganic active oxygen compound.

5. The composition of claim 4, wherein the inorganic active oxygen compound comprises hydrogen peroxide, hydrogen peroxide adduct, group IIIA active oxygen compound, group VIA active oxygen compound, group VA active oxygen compound, group VIIA active oxygen compound, or mixtures thereof.

6. The composition of claim 5, wherein the inorganic active oxygen compound comprises percarbonate, perborate, persulfate, perphosphate, persilicate, or mixtures thereof.

7. The composition of claim 1, wherein the organic sequestrant comprises amino tri(methylene phosphonic) acid; 1-hydroxyethylidene-1,1-diphosphonic acid; diethylenetriaminopenta(methylene phosphonic) acid; alanine-N,N-diacetic acid; diethylenetriaminepentaacetic acid; salts thereof; or mixtures thereof.

8. The composition of claim 1, wherein the solidified mixture comprises a binding agent comprising the organic sequestrant, the active oxygen compound, and water.

9. The composition of claim 1, further comprising source of alkalinity, surfactant, detergent builder, cleaning enzyme, detersive polymer, antimicrobial agent, activator for the active oxygen compound, or combinations thereof.

10. The composition of claim 9, wherein the surfactant comprises alkyl phenol ethoxylate, linear and secondary alcohol ethoxylate, ethoxy/propoxy block surfactant, polyether siloxane, or a mixture thereof.

11. The composition of claim 9, wherein the detergent builder comprises sodium tripolyphosphate, potassium tripolyphosphate, nitrilotetraacetate, ethylene diamine tetraacetate, or mixtures thereof.

12. The composition of claim 9, wherein the activator for the active oxygen compound comprises tetraacetylethylene diamine; transition metal; compound that comprises carboxylic, nitrile, amine, or ester moiety; or mixtures thereof.

13. The composition of claim 1, comprising aminocarboxylate and further comprising chelating agent; the chelating agent comprising polycarboxylate.

14. The composition of claim 13, wherein the aminocarboxylate comprises nitrilotriacetic acid, ethylenediaminetetraacetic acid, salt thereof, or mixture thereof.

15. The composition of claim 13, wherein the polycarboxylate comprises citric acid or a salt thereof.

16. A solid or agglomerated cleaning composition comprising a solidified mixture of:
an organic sequestrant comprising a phosphonate, an aminocarboxylate, or mixtures thereof;
an active oxygen compound comprising peroxygen moiety;
water; and
alkali metal salt;
wherein when the combined moles of peroxygen moiety and water in the mixture are greater than the number of moles of alkali metal salt.

17. The composition of claim 16, wherein the alkali metal salt comprises sodium carbonate, potassium carbonate, sodium bicarbonate, potassium bicarbonate, or mixtures thereof.

18. The composition of claim 17, comprising less than 8 moles of active oxygen compound for each mole of organic sequestrant.

19. The composition of claim 17, comprising 5 to 15 moles of water for each mole of organic sequestrant.

20. The composition of claim 16, wherein the active oxygen compound comprises inorganic active oxygen compound.

21. The composition of claim 20, wherein the inorganic active oxygen compound comprises hydrogen peroxide, hydrogen peroxide adduct, group IIIA active oxygen compound, group VIA active oxygen compound, group VA active oxygen compound, group VIIA active oxygen compound, or mixtures thereof.

22. The composition of claim 20, wherein the inorganic active oxygen compound comprises percarbonate, perborate, persulfate, perphosphate, persilicate, or mixtures thereof.

23. The composition of claim 16, wherein the organic sequestrant comprises amino tri(methylene phosphonic) acid; 1-hydroxyethylidene-1,1-diphosphonic acid; diethylenetriaminopenta(methylene phosphonic) acid; alanine-N,N-diacetic acid; diethylenetriaminepentaacetic acid; salts thereof; or mixtures thereof.

24. The composition of claim 23, wherein the salt comprises alkali metal salt, alkaline earth metal salt, amine salt, transition metal salt, or mixtures thereof.

25. The composition of claim 16, comprising aminocarboxylate and further comprising chelating agent; the chelating agent comprising polycarboxylate.

26. The composition of claim 25, wherein the aminocarboxylate comprises nitrilotriacetic acid, ethylenediaminetetraacetic acid, salt thereof, or mixture thereof.

27. The composition of claim 25, wherein the polycarboxylate comprises citric acid or a salt thereof.

28. A method of cleaning an carpet, upholstery, or laundry, comprising:
contacting the carpet, upholstery, or laundry with a use composition comprising a dissolved or suspended cleaning composition;
the cleaning composition comprising a solidified mixture of:
an organic sequestrant comprising phosphonate, aminocarboxylate, or mixtures thereof;
active oxygen compound comprising peroxygen moiety; and
water;
wherein the combined moles of peroxygen moiety and water in the mixture are greater than the number of moles of active oxygen compound.

29. A method of cleaning carpet, upholstery, or laundry, comprising:
contacting the carpet, upholstery, or laundry with a use composition comprising a dissolved or suspended cleaning composition;
the cleaning composition comprising a solidified mixture of:
an organic sequestrant comprising a phosphonate, an aminocarboxylate, or mixtures thereof;
an active oxygen compound comprising peroxygen moiety;
water; and
alkali metal salt;
wherein when the combined moles of peroxygen moiety and water in the mixture are greater than the number of moles of alkali metal salt.

30. The method of claim 28, comprising cleaning carpet or upholstery.

31. The method of claim 30, wherein applying comprises extracting the carpet or upholstery.

32. The method of claim 30, wherein applying comprises brushing or rubbing the cleaning composition on the carpet.

33. The method of claim 30, wherein applying comprises pre-spotting, pre-spraying, or extracting the carpet or upholstery, or combinations thereof.

34. The method of claim 30, comprising applying the cleaning composition at a concentration and for a duration effective to achieve sanitizing the carpet or upholstery.

35. The method of claim 30, further comprising removing a portion of the composition from the carpet.

36. The method of claim 30, wherein the method omits pre-spotting the carpet or upholstery.

37. The method of claim 30, wherein the method omits pre-spraying the carpet or upholstery.

38. The method of claim 30, wherein the dissolved or suspended cleaning composition comprises about 0.1 to about 10 wt-% of the solid or agglomerated cleaning composition, and a pH of about 7 to about 11.

39. The method of claim 28, comprising cleaning laundry.

40. The method of claim 39, comprising presoaking laundry.

41. The method of claim 39, comprising sanitizing laundry.
